(19) United States
(12) Patent Application Publication
(10) Pub. No.: US 2012/0283858 A1
(43) Pub. Date: Nov. 8, 2012

(54) COMPUTERIZED SYSTEM AND METHOD FOR MANAGING FANTASY SPORTS TEAM

(75) Inventor: Len Lapadula, Rochester, NH (US)

(73) Assignee: ADVANCED SPORTS LOGIC, INC., ROCHESTER, NH (US)

(21) Appl. No.: 13/520,254

(22) PCT Filed: Jan. 3, 2011
(86) PCT No.: PCT/US11/20037

§ 371 Date: Jul. 2, 2012

Related U.S. Application Data
(60) Provisional application No. 61/298,207, filed on Jan. 25, 2010.

(51) Int. Cl. G06F 19/00

(52) U.S. Cl. 700/93

(57) ABSTRACT

The present invention is a computerized system and method for managing a fantasy sports team. The system and method includes a computer for processing league and player information, devices for inputting information, such as Internet connections for league and player information, devices for a user to add or modify league and player information and to initiate tasks for the system to perform such as a keyboard and mouse, and a display device or e-mail generation for conveying information as a result of the tasks. The system and method is able to measure and generate all possible team management decisions based on the impact to the probability of winning the league championship.

This application claims priority to U.S. Provisional Application 61/298,207 filed on Jan. 25, 2010, the entire disclosure of which is incorporated by reference.

### TECHNICAL FIELD & BACKGROUND

The present invention relates generally to a system and method for fantasy sports activities. More specifically, the invention relates to a computerized system and method for managing a fantasy sports team, to measure a team's probability of winning, and to recommend team transactions that increase probability of winning.

### DESCRIPTION OF THE RELATED ART

Various forms of information and computer software are available to help fantasy team owners make team management decisions. Player draft guides, for example, provide a subjective analysis of players that the author anticipates will do well, by labeling players or by ordering the best players. However, such guides include static information and do not take into account league specific rules and schedules and are not intended to provide specific guidance to a fantasy team manager.

In another form of the present state of the art, commercially available player projections are available for use by a fantasy team manager. Player projections might be obtained from various sources but are for the most part, based on simulation results or on statistical models from past results and typically involve some type of subjective analysis. Draft software might be provided with the player projections along with a spreadsheet-like application to help prioritize and rank players available when a team manager is on the clock. Some draft software provides draft recommendations based on the average draft position data from recent mock drafts.

Other draft software might allow for customization based on league specific rules and yet other draft software might consider the relative value of a player for his position compared with other positions. The current draft software available seeks to maximize the fantasy points a fantasy team will score, based on projections. However, maximum fantasy point projections might break down when trying to factor in the true value of player back-ups. The software does not commonly take into account the fantasy team's match-up schedule, the accuracy of the projections, injury data, nor does the software consider play-off schedules and many league rules, such as playoff seeding rules or victory points.

A fantasy team manager might utilize starting line-up software that functions to recommend an optimal starting line-up, given players' statistical projections and a specific set of scoring rules, such as whether rotisserie style scoring is employed and where a player achieves fantasy points relative to the performance of other players in a common league. These optimal starting line-up recommendations are also based on fantasy point projections, but do not consider a probability distribution.

For example, if a major league baseball pitcher is projected to pitch ten strikeouts and the next best pitcher is projected to pitch nine strikeouts, a starting line-up recommendation might give the same value to the ten strikeout pitcher as to a twelve strikeout pitcher. However, in reality projections have an element of uncertainty, commonly referred to in the art as a statistical deviation. Thus, the pitcher projected to pitch twelve strikeouts has a certain likelihood of pitching more strikeouts than the pitcher projected to pitch nine strikeouts. In comparison, the pitcher projected to pitch ten strikeouts has a lesser likelihood than the twelve strikeout pitcher, based on a probability distribution of pitching more strikeouts than the pitcher projected to pitch nine strikeouts.

The inventor has recognized that the prior art fails to provide fantasy sports team managers with tools that can assist in evaluating decisions based on the probability of a desired outcome. What is needed is an objective method for use in fantasy team application whereby a management decision can be made on the basis of the fantasy sports team's probability of achieving an ultimate outcome, such as winning a league championship.

### BRIEF DESCRIPTION OF THE DRAWINGS

The present invention will be described by way of exemplary embodiments, but not limitations, illustrated in the accompanying drawings in which like references denote similar elements and in which:

FIG. 1 is a diagrammatical illustration of a computerized system for managing a fantasy sports team, in accordance with one embodiment of the present invention.

FIG. 2 is a flow diagram illustrating the method steps performed by the fantasy sports team management software shown in FIG. 1, in accordance with one embodiment of the present invention.

FIG. 3 is a functional block diagram of the team management software run on the computerized system of FIG. 1, in accordance with one embodiment of the present invention.

FIG. 4 is a graphical user interface Home page run on the computerized system of FIG. 1, in accordance with one embodiment of the present invention.

FIG. 5 illustrates the pull down menus used to navigate all of the functions of the team management software of FIG. 2, in accordance with one embodiment of the present invention.

FIG. 6 is a Player Projections: View/Edit Player Projections graphical user interface page accessed from the pull down menus of FIG. 4 that performs the 3^{rd} Party Player Projections User Edits function of FIG. 3, in accordance with one embodiment of the present invention.

FIG. 7 is a Player Projections: Bump-Up/Bump-Down Report graphical user interface page accessed from the pull down menus of FIG. 4, in accordance with one embodiment of the present invention.

FIG. 8 is a graphical depiction of a Data Type 1, 16-Point Probability Distribution, where the Y-axis represents the probability the distribution will fall in one of the sixteen bins of the X-axis, used to implement the math functions in the projection conversion and season calculator functions of the Team Management software of FIG. 3, in accordance with one embodiment of the present invention.

FIG. 9 illustrates the relationship of a Data Type 2, 16-point set of assigned fantasy points (seen on the X-axis), to the Data Type 1, a 16-point probability distribution, used to implement the math functions in the projection conversion and season calculator functions of the Team Management software of FIG. 3, in accordance with one embodiment of the present invention.

FIG. 10 is an output of Function 1, The Normal Distribution Function, used in the projection conversion function of the Team Management software of FIG. 3, in accordance with one embodiment of the present invention.

FIG. 11 is a functional block diagram showing how player projections shown on the Player Projections: View/Edit Player Projections graphical user interface page of FIG. 6 are converted to league specific probability distribution data as part of the projection conversion function of FIG. 3, in accordance with one embodiment of the present invention.

FIG. 12 is a Player Projections: View Player Probability Distributions graphical user interface page accessed from the pull down menus of FIG. 4 showing player probability distributions generated by adding additional deviation and zero fantasy point event probability to the projection distributions generated per the projection conversion function of FIG. 3 shown in more detail in FIG. 11, in accordance with one embodiment of the present invention.

FIG. 13 is a League Set-up: Teams and Divisions graphical user interface page accessed from the pull down menus of FIG. 4 illustrating a method of entering team name and league division data as part of the League Rules and Schedule of FIG. 3, in accordance with one embodiment of the present invention.

FIG. 14 is a League Set-up: Offensive Player Scoring Rules graphical user interface page accessed from the pull down menus of FIG. 4 illustrating a method of entering offensive player scoring rules as part of the League Rules and Schedule of FIG. 3, in accordance with one embodiment of the present invention.

FIG. 15 is a League Set-up: Defensive Player Scoring Rules graphical user interface page accessed from the pull down menus of FIG. 4 illustrating a method of entering defensive player scoring rules as part of the League Rules and Schedule of FIG. 3, in accordance with one embodiment of the present invention.

FIG. 16 is a League Set-up: Defense and Special Teams Scoring Rules graphical user interface page accessed from the pull down menus of FIG. 4 illustrating a method of entering defense and special teams scoring rules as part of the League Rules and Schedule of FIG. 3, in accordance with one embodiment of the present invention.

FIG. 17 is a League Set-up: Draft Order graphical user interface page accessed from the pull down menus of FIG. 4 illustrating a method of entering default draft order as part of the League Rules and Schedule of FIG. 3, in accordance with one embodiment of the present invention.

FIG. 18 is a League Set-up: Starting Line-up Rules graphical user interface page accessed from the pull down menus of FIG. 4 illustrating a method of entering starting line-up rules as part of the League Rules and Schedule of FIG. 3, in accordance with one embodiment of the present invention.

FIG. 19 is a League Set-up: Match-Up Schedule graphical user interface page accessed from the pull down menus of FIG. 4 illustrating a method of entering the league match-up schedule as part of the League Rules and Schedule of FIG. 3, in accordance with one embodiment of the present invention.

FIG. 20 is a League Set-up: Waivers/Trading Rules graphical user interface page accessed from the pull down menus of FIG. 4 illustrating a method of entering league waiver and trading rules as part of the League Rules and Schedule of FIG. 3, in accordance with one embodiment of the present invention.

FIG. 21 is a League Set-up: Victory Point Rules graphical user interface page accessed from the pull down menus of FIG. 4 illustrating a method of entering victory point rules as part of the League Rules and Schedule of FIG. 3, in accordance with one embodiment of the present invention.

FIG. 22 is a League Set-up: Playoff Seeding/Schedule graphical user interface page accessed from the pull down menus of FIG. 4 illustrating a method of entering playoff seeding rules as part of the League Rules and Schedule of FIG. 3, in accordance with one embodiment of the present invention.

FIG. 23 is a League Set-up: Keeper League Rules graphical user interface page accessed from the pull down menus of FIG. 4 illustrating a method of entering keeper rules as part of the League Rules and Schedule of FIG. 3, in accordance with one embodiment of the present invention.

FIG. 24 illustrates a method of filling open roster spots from available pseudo players as part of the Preseason Mock Draft Task of FIG. 3, in accordance with one embodiment of the present invention.

FIG. 25 is a functional flow diagram of a season calculator of the team management software of FIG. 3, in accordance with one embodiment of the present invention.

FIG. 26 illustrates Function 3, used for finding the aggregate of two probability distributions for finding the value of having back-up players for a starting line-up as part of the Build Aggregate Fantasy Point Distributions function of FIG. 25, in accordance with one embodiment of the present invention.

FIG. 27 shows how Function 3 of FIG. 26 is cascaded to value multiple back-up players by aggregating their probability for Stage 1 of the Build Aggregate Fantasy Point Distributions function of FIG. 25, in accordance with one embodiment of the present invention.

FIG. 28 illustrates Function 5, used for adding additional deviation to an existing probability distribution for Stage 2 of the Build Aggregate Fantasy Point Distributions function of FIG. 25, in accordance with one embodiment of the present invention.

FIG. 29 is a functional block diagram showing how Function 5 of FIG. 28 is used to add the league-normalized standard deviation of current week fantasy point projections to actual fantasy point results (STDpa) to the Stage 1 aggregate probability distributions out of FIG. 27 for Stage 2 of the Build Aggregate Fantasy Point Distributions function of FIG. 25, in accordance with one embodiment of the present invention.

FIG. 30 illustrates Function 2, used for adding the probability of a zero fantasy point event to an existing probability distribution for the final stage of the Build Aggregate Fantasy Point Distributions function of FIG. 25, in accordance with one embodiment of the present invention.

FIG. 31 is a functional block diagram showing how Function 2 of FIG. 30 is used to the combined probability of all zero fantasy point events (CPZ) for N weeks in the future to the Stage 2 aggregate probability distributions out of FIG. 29 for the final stage of the Build Aggregate Fantasy Point Distributions function of FIG. 25, in accordance with one embodiment of the present invention.

FIG. 32 illustrates intermediate data points (top) and binning the intermediate data to sixteen Data Type 2 bins (bottom) for Function 4, used for summing two probability distributions of starter together for the Calculate Weekly Team Fantasy Point Distributions Probability function of FIG. 25, in accordance with one embodiment of the present invention.

FIG. 33 is a functional block diagram showing how Function 4 of FIG. 32 is cascaded to combine the fantasy point probability distributions of multiple starting line-up spots for the Calculate Weekly Team Fantasy Point Distributions Probability function of FIG. 25, in accordance with one embodiment of the present invention.

FIG. 34 illustrates Function 6, the probability that Distribution 1 will result in more fantasy points than Distribution 2, where the series 1 distribution has a fifty-five percent (55%) of resulting in more fantasy points than the Series 2 distribution for the Calculate Weekly Match-Up Results function of FIG. 25, in accordance with one embodiment of the present invention.

FIG. 35 is a functional block diagram showing how Function 6 of FIG. 34 is used once for calculating the probability Team A is to win a match-up over Team B and vice versa for the Calculate Weekly Match-Up Results function of FIG. 25, in accordance with one embodiment of the present invention.

FIG. 36 is a functional block diagram showing how the probability of wins (PW) calculated with the function of FIG. 35 are cascaded for the probability of falling within a certain grouping of the weekly results for calculating weekly victory point bonuses for the Calculate Victory Points function of FIG. 25, in accordance with one embodiment of the present invention.

FIG. 37 is a Preseason Actions: Mock Draft graphical user interface page accessed from the pull down menus of FIG. 4 illustrating a method of viewing mock draft results and the relative value of positions and players based on actual league rules of the Preseason Tasks/Mock Draft of FIG. 3, in accordance with one embodiment of the present invention.

FIG. 38 is a Preseason Actions: Keeper Recommendations graphical user interface page accessed from the pull down menus of FIG. 4 illustrating a method of viewing keeper recommendations of the Preseason Tasks/Keepers of FIG. 3, in accordance with one embodiment of the present invention.

FIG. 39 is a Preseason Actions: Keeper Trades graphical user interface page illustrating a method of viewing keeper trade recommendations of the Preseason Tasks/Trades of FIG. 3, in accordance with one embodiment of the present invention.

FIG. 40 is a Preseason Actions: Draft Pick Trades graphical user interface page accessed from the pull down menus of FIG. 4 illustrating a method of viewing draft pick trade recommendations of the Preseason Tasks/Trades of FIG. 3, in accordance with one embodiment of the present invention.

FIG. 41 is a Preseason Actions: Draft Pick Recommendations graphical user interface page accessed from the pull down menus of FIG. 4 illustrating a method of entering draft picks of other teams and viewing draft pick recommendations of the Preseason Tasks/Draft of FIG. 3, in accordance with one embodiment of the present invention.

FIG. 42 is a Regular Season Actions: Waiver Recommendations graphical user interface page accessed from the pull down menus of FIG. 4 illustrating a method of viewing waiver recommendations of the Regular Season Tasks/Waivers of FIG. 3, in accordance with one embodiment of the present invention.

FIG. 43 is a Regular Season Actions: Waiver Transactions graphical user interface page accessed from the pull down menus of FIG. 4 illustrating a method of entering league waiver transactions recommendations of the Regular Season Tasks/Waivers function of FIG. 3, in accordance with one embodiment of the present invention.

FIG. 44 is a Regular Season Actions: Trade Recommendations graphical user interface page accessed from the pull down menus of FIG. 4 illustrating a method of viewing trade recommendations of the Regular Season Tasks/Trades function of FIG. 3, in accordance with one embodiment of the present invention.

FIG. 45 is a Regular Season Actions: Trade Exploration graphical user interface page accessed from the pull down menus of FIG. 4, illustrating a method of exploring possible trades and generating counter offer trade recommendations of the Regular Season Tasks/Trades function of FIG. 3, in accordance with one embodiment of the present invention.

FIG. 46 is a Regular Season Actions: Trade Transactions Recording graphical user interface page accessed from the pull down menus of FIG. 4 illustrating a method of entering league waiver transactions recommendations of the Regular Season Tasks/Trades function of FIG. 3, in accordance with one embodiment of the present invention.

FIG. 47 is a Regular Season Actions: Roster Review and Edit graphical user interface page accessed from the pull down menus of FIG. 4 illustrating a method of viewing and editing rosters as a result of unrecorded transactions of the Regular Season Tasks function of FIG. 3, in accordance with one embodiment of the present invention.

FIG. 48 is a Regular Season Actions: Starting Line-up Recommendations graphical user interface page accessed from the pull down menus of FIG. 4 illustrating a method of viewing starting line-up recommendations of the Regular Season Tasks/Starting Line-Up function of FIG. 3, in accordance with one embodiment of the present invention.

FIG. 49 is a Regular Season Actions: Enter Weekly Results graphical user interface page accessed from the pull down menus of FIG. 4 illustrating a method of entering weekly results of the Regular Season Tasks function of FIG. 3, in accordance with one embodiment of the present invention.

FIG. 50 is a League Projection Details graphical user interface page accessed from the pull down menus of FIG. 4 illustrating a method of viewing league summary details such as win and loss match-up and playoff seeding probabilities and team fantasy point projection probability distributions of the Regular Season Tasks function of FIG. 3, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

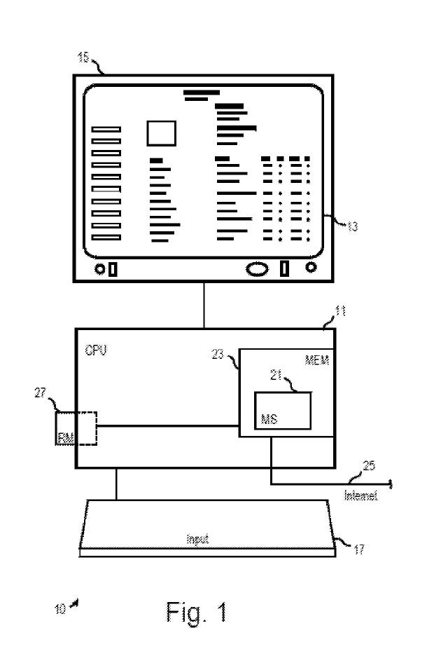

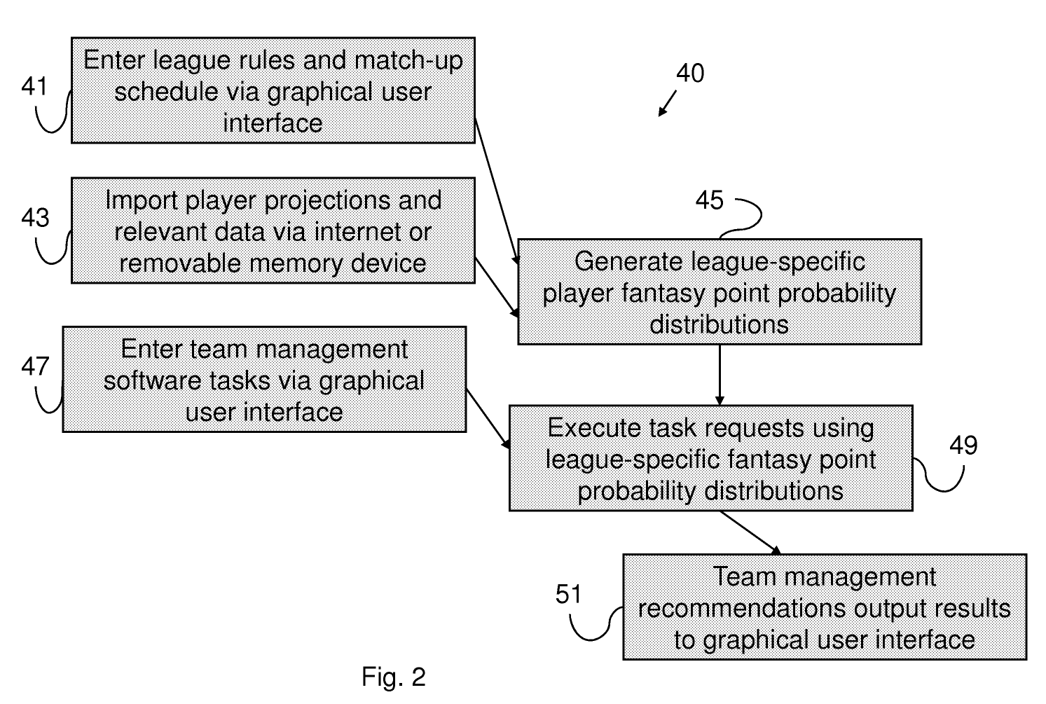

The disclosed system and method provides a fantasy sports team manager an analytical tool to convert commercially available sports team and player projection information into comprehensive and league specific recommendations for the fantasy sports team manager in attempting to guide his team to a defined goal such as a league championship (for example). In one embodiment of the present invention, the fantasy sports team manager might access a computer system 10, shown in FIG. 1, for performing the method of managing a fantasy sports team described in greater in the FIG. 2 description. The computer system 10 might comprise a computer 11, such as a laptop, a desktop, or a hand-held device, providing various display information 13 to the fantasy sports team manager by means of a display device 15, that might be provided as part of a laptop monitor, a separate monitor unit or the display of a hand-held device.

The fantasy sports team manager may input data via a keyboard 17 and an optional mouse (not shown), as is well known in the art. Fantasy sports team management software 21, in accordance with an aspect of the present invention, might be pre-loaded onto a computer memory 23 or accessed on a server over the Internet 25. In addition, the computer 11 might receive updated information via a subscription service over the Internet 25, for example. Alternatively, updated information might be loaded into the computer 11 by a removable memory 27, such as an optical storage device, flash memory or other removable memory device.

The disclosed method can be described briefly with additional reference to a flow diagram 40, in FIG. 2, illustrating the operation of the fantasy sports team management software 21. The fantasy sports team manager, or other user, might access the computer system 10 to set-up the league rules and match-up schedule provided by a graphical user interface on the display device 15, as described in greater detail in step 41. Relevant and updated sports data might be imported into the computer system 10 via the Internet 25, in step 43. The relevant sports data might be processed, at step 45, using probability functions, as described in greater detail in the subsequent figure descriptions. After the data has been processed, the team manager or other user might enter team management software tasks, in step 47, which then cause the team management software 21 to perform tasks using the league specific player fantasy point projections, in step 49, to produce team management recommendations, such as keeper recommendations, draft pick recommendations, waiver recommendations or trade recommendations viewable to the team manager via a graphical user interface at step 51.

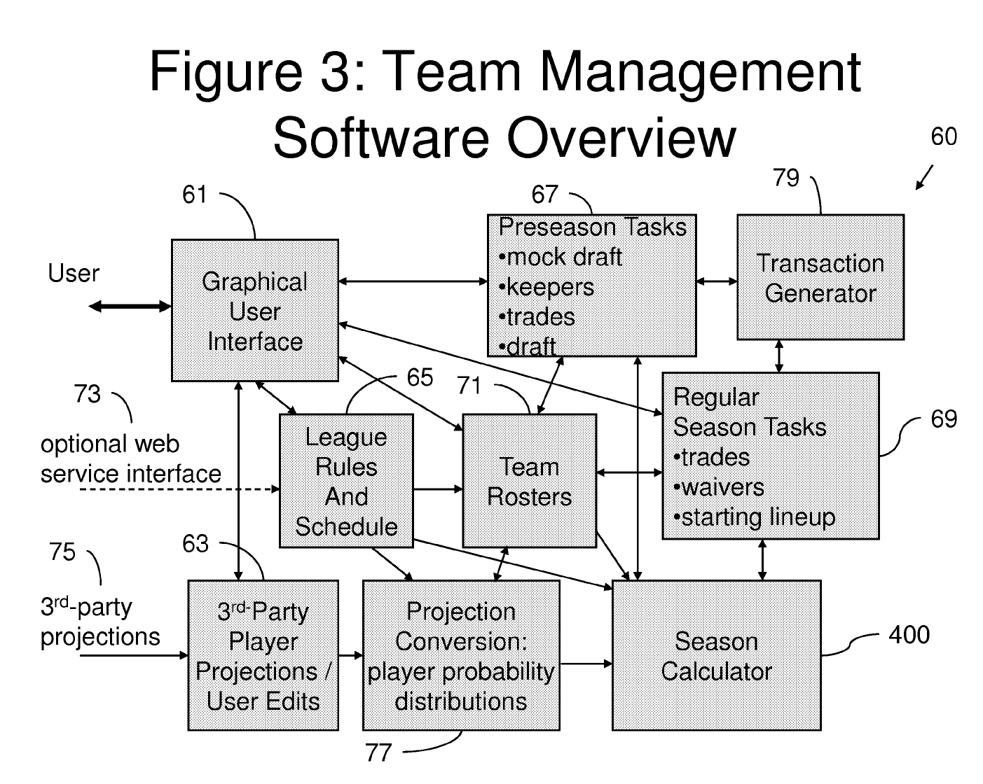

The team management software 21 might be organized as represented in a functional block diagram 60 as shown in FIG. 3. The team manager or user, accesses all functions of the team management software 21 through a graphical user interface 61 for 3^{rd} party projections which can first be viewed and edited by the user 63. Then league rules and schedules need to be set-up 65 either by the user or through an optional web service interface 73 specific to the 3^{rd} party providing the team management software 21. Once player projections, league rules and league schedules are set-up, the team management software 21 converts the player projections to league specific fantasy point player probability distributions that also include the probability of a zero fantasy point event 77. These league projections are an input into the season calculator 400. The season calculator 400 then uses team rosters 71, league rules and schedules 65 and league specific player fantasy point projections 77 to perform a simulation of the entire fantasy football season using probability distributions and probability functions rather than single whole numbers or mean values. A transaction generator 79 is also present that generates possible transactions the team manager might want to make in his league. Preseason transactions are requested by, processed and pruned down by a preseason task manager 67 and regular season transactions are requested by, processed and pruned down by a regular season task manager 69. For example, the transaction generator 79 might create millions of possible player trade proposals. The regular season task manager will process these possible trade proposals by first determining if a proposal meets certain criteria for running through the season calculator 400. If so, the team rosters 71 are temporarily modified to reflect the trade and the season calculator 400 is run. If the season calculation results meet certain criteria, such as improving the team manager's team's probability of winning a championship, it is displayed on the graphical user interface 61 as a recommended trade for the team manager to propose. Examples of possible preseason tasks are conducting a mock draft, deciding keepers, proposing and evaluating keeper and draft pick trades and making draft selections. Examples of possible regular season tasks are proposing and evaluating player trades, deciding waiver selections and deciding a starting line-up.

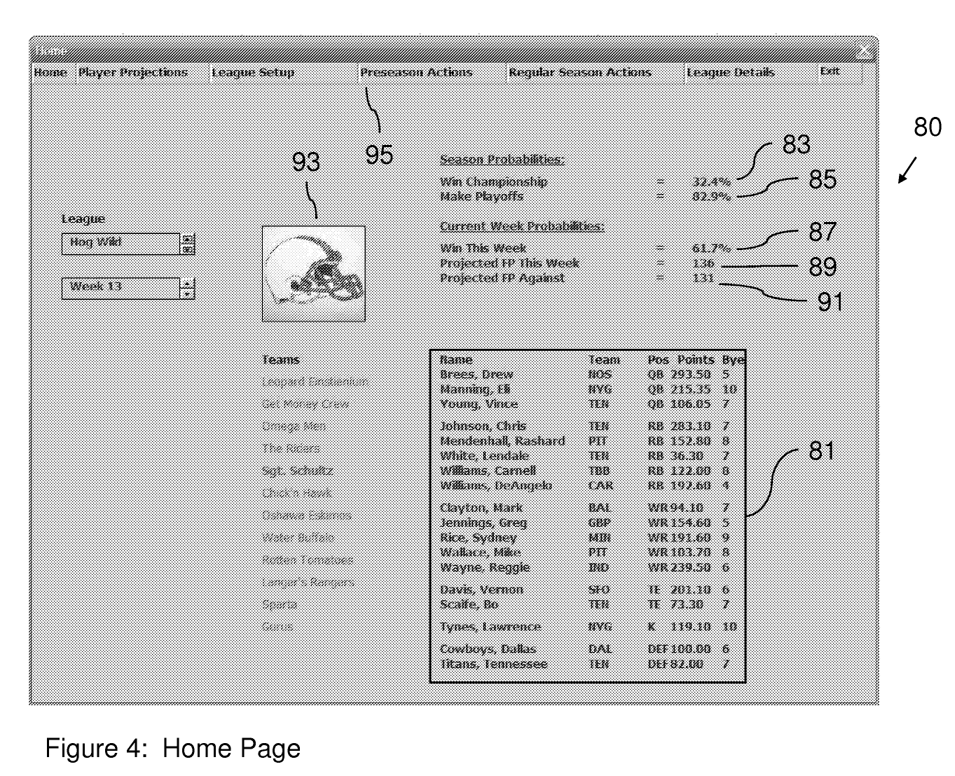

In one embodiment, the graphical user interface 61 might comprise a Home Page 80 as shown in FIG. 4. The Home Page 80 might include high level league summary information of interest to the team manager such as one or more team roster data fields 81, the probability that the team manager will win the league championship 83, the probability that the team manager will qualify for the playoffs 85, the probability that the team manager will win the current week's match-up 87, the projected fantasy points for the team manager for the current week 89, the projected fantasy points for the opposing team for the current week 91, a team icon 93 to personalize the graphical user interface and a navigation menu 95 for accessing functions of the team manager software 21.

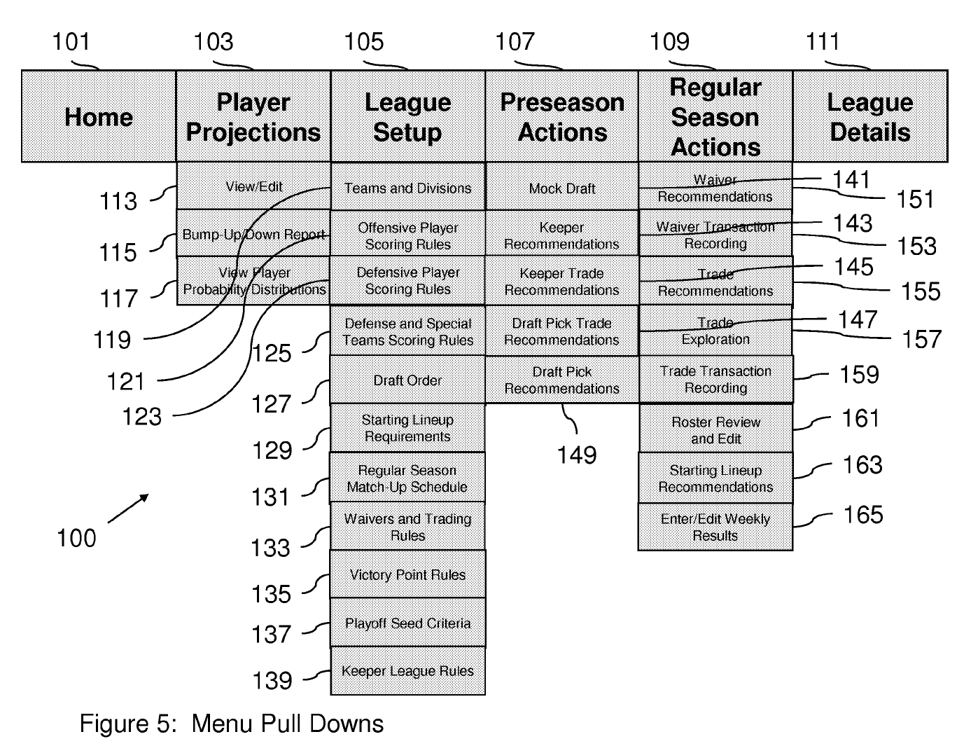

In an exemplary embodiment, the graphical user interface 61 might utilize pull-down menus 100 as shown in FIG. 5 to enable the team manager to navigate the functions provided by the team manager software 21. The top level navigation options might include Home 101, Player Projections 103, League Set-Up 105, Preseason Actions 107, Regular Season Actions 109 and League Details 111. Player Projections 103 options might include View/Edit 113, Bump-Up/Bump-Down Report 115 and View Player Probability Distributions 117. League Set-up 105 options might include Teams and Divisions 119, Offensive Player Scoring Rules 121, Defensive Player Scoring Rules 123, Defense and Special Teams Scoring Rules 125, Draft Order 127, Starting Line-up Requirements 129, Regular Season Match-Up Schedule 131, Waivers and Trading Rules 133, Victory Point Rules 135, Playoff Seed Criteria 137 and Keeper League Rules 139. The Preseason Actions 107 might include Mock Draft 141, Keeper Recommendations 143, Keeper Trade Recommendations 145, Draft Pick Trade Recommendations 147 and Draft Pick Recommendations 149. The Regular Season Actions 109 might include Waiver Recommendations 151, Waiver Transaction Recording 153, Trade Recommendations 155, Trade Exploration 157, Trade Transaction Recording 159, Roster Review and Edit 161, Starting Line-up Recommendations 163 and Enter/Edit Weekly Results 165.

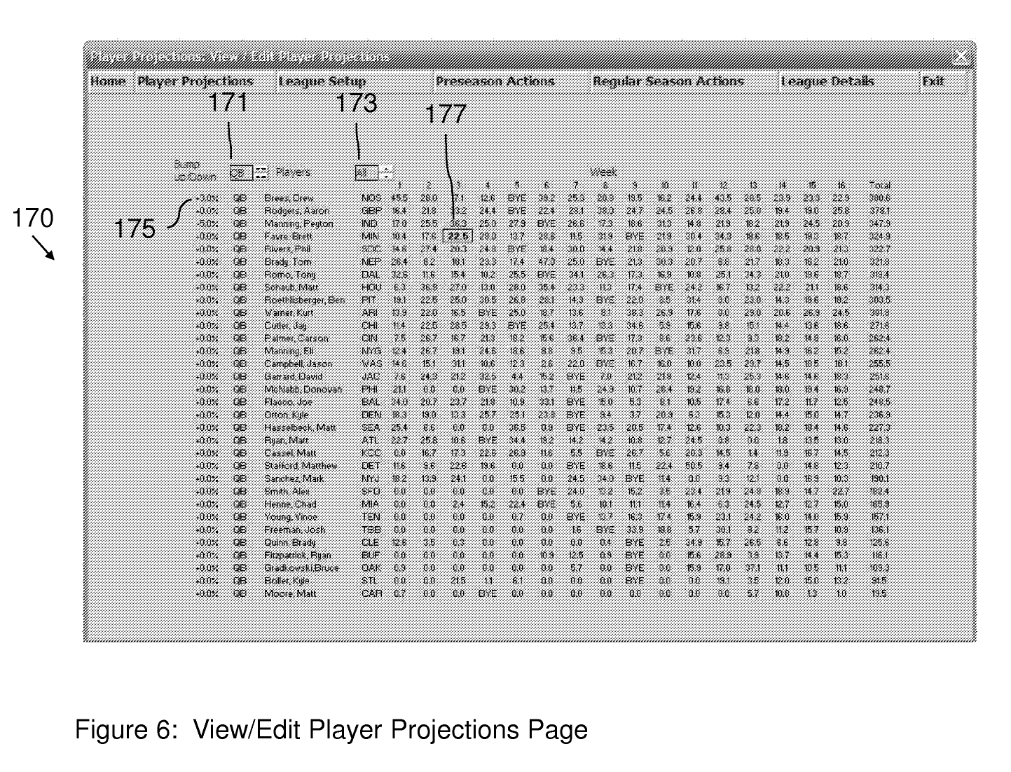

A View/Edit Player Projections page 170 shown in FIG. 6 enables the team manager to view 3^{rd} party player projections 71 and edit the projections 63 based on preference and expert knowledge. The team manager might sort players by position 171 or the player's professional sports team name 173 and the team manager might bump-up or down the player's entire season projections by some percentage 175 or edit the projection of a player for a specific week directly 177.

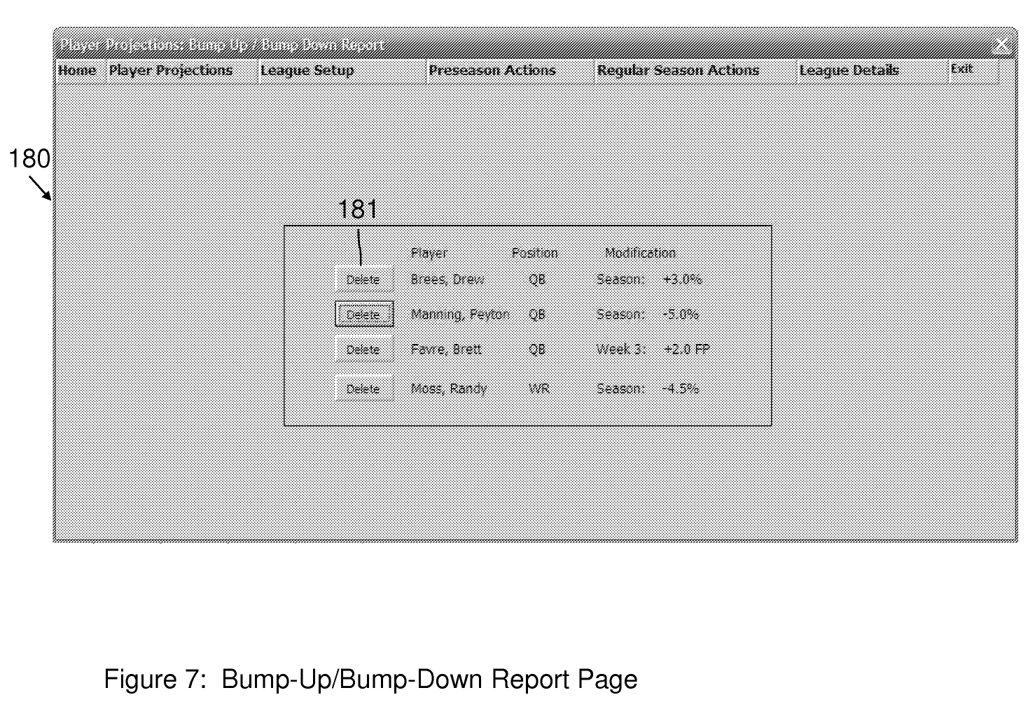

A Bump-Up/Bump-Down page 180 shown in FIG. 7 enables the team manager to view only the bump-up/bump-down edits in effect from 3^{rd} party projection 71 edits made on the View/Edit Player Projections page 170. For each bump-up or bump-down, a delete button 181 is provided so the team manager can remove the bump-up or bump-down and the projection for the specific player returns to the default value provided by the 3^{rd} party.

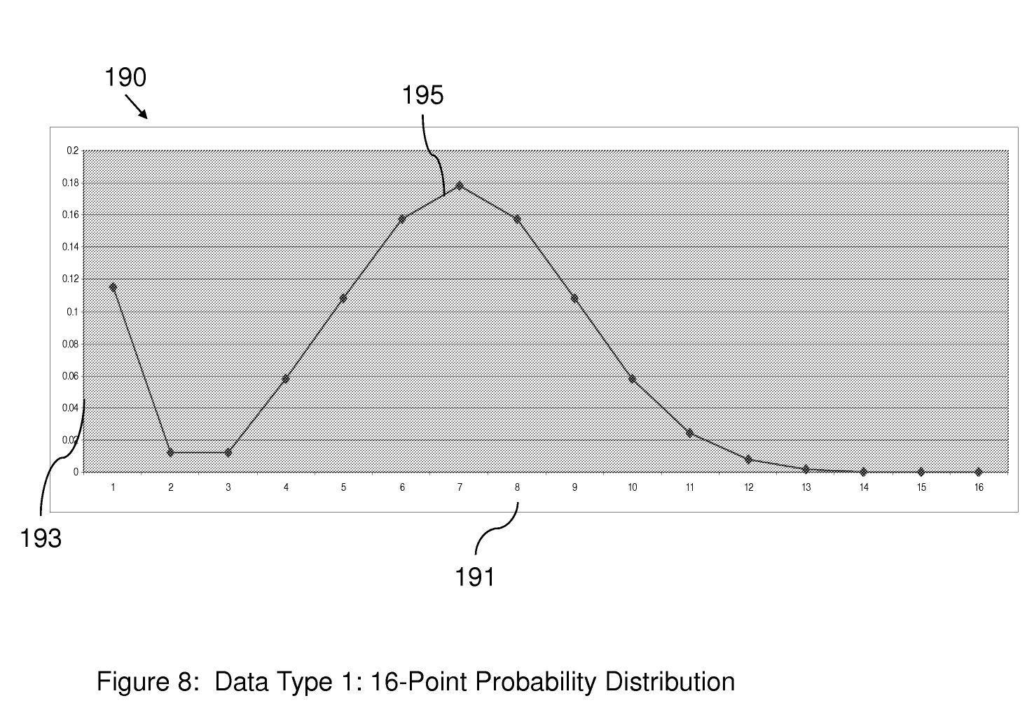

The team management software 21 converts the user modified player projections 63 to probability distributions 77 for use by the season calculator 400. The math required by the method and system for a projection conversion function 77 and the season calculator 400 can be implemented various ways with different data types. In another embodiment targeted for computing efficiency and maximum benefit to the team manager, two data types are used primarily for representing fantasy point probability distributions. The first data type, Data Type 1, is a set of sixteen floating point numbers representing a probability distribution as shown in FIG. 8. FIG. 8 shows a typical player probability distribution 190, where the x-axis 191 represents bins that each represent a range of fantasy points and the y-axis 193 represents a statistical probability. Each point on the graph 195 in FIG. 8 represents the probability that the player will achieve the range of fantasy points represented by the bin. The first point represents the probability that data will fall in the range from minus infinity to halfway between the first bin and the second bin. The second through fifteenth points each represent the probability that data will fall in the range halfway from the previous bin to halfway to the next bin. The sixteenth point represents the probability that data will fall in the range from halfway between the fifteenth bin and the sixteenth bin to infinity. The exact midpoint between two bins belongs to the higher bin. The sum of all sixteen probabilities of Data Type 1 is always one.

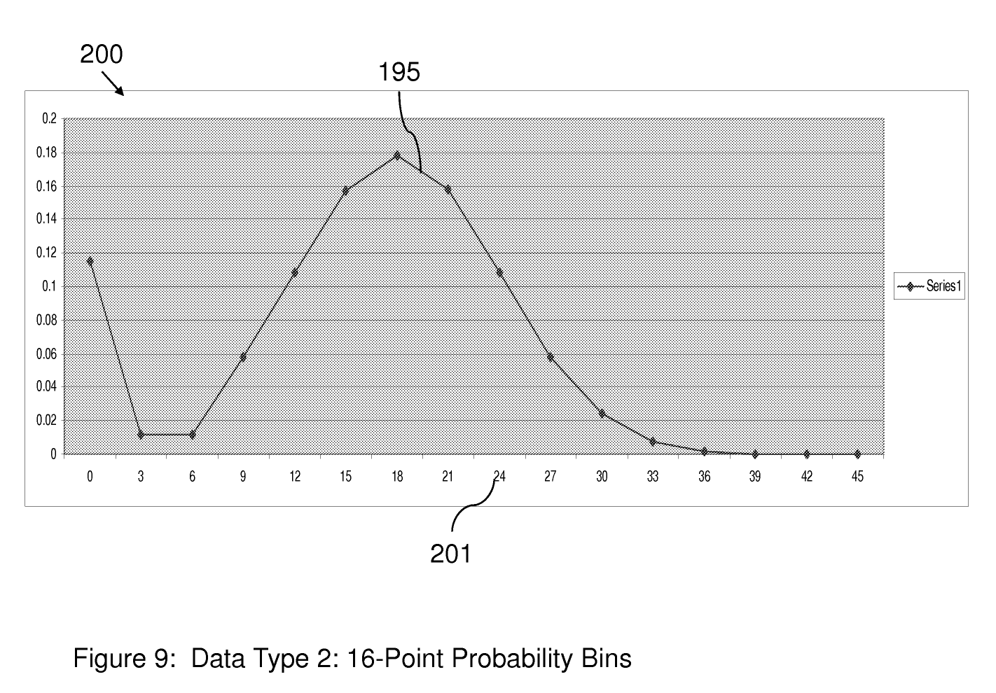

The second data type, Data Type 2, is a set of sixteen floating point numbers representing the range that each point of a probability distribution represented by the Data Type 1 falls in. For the exemplary embodiment, bins are always evenly spaced so that the incremental difference from one bin to the next is the same for all bins. FIG. 9 shows a graph 200 of the same probability distribution 195 as FIG. 8, but the x-axis has values that indicate the mid-point of the range of each bin 201, except for the first and last bins which extend to plus and minus infinity respectively.

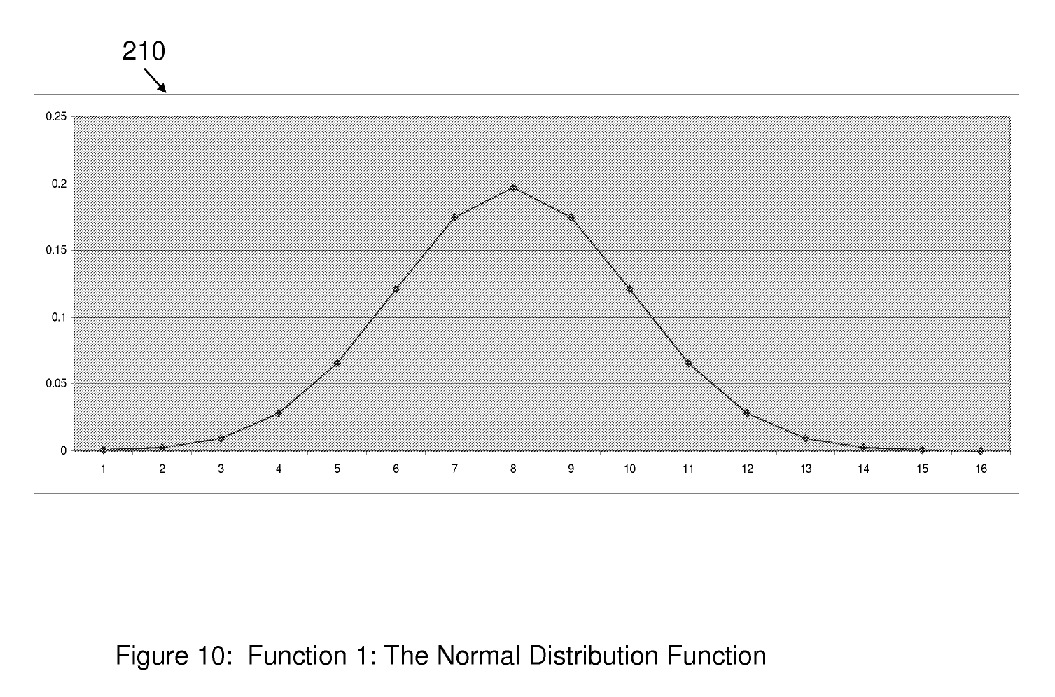

The method for converting player projections into probability distributions 77 requires the use of the normal distribution function, referred herein as Function 1. In one embodiment, the normal distribution function of the inputs are a mean projection value, a value for standard deviation and a set of fantasy point probability bins of Data Type 2 201. The output is a normal distribution represented as Data Type 1 195. FIG. 10 shows a graph of Data Type 1 210 for a normal distribution centered on bin 8 and with a mean of 22.5, a standard deviation of 6 and Data Type 2 ranging from 0 to 45. FIG. 10 only shows the sixteen bin numbers on the x-axis because Data Type 2 is an input, not an output of Function 1.

In one embodiment, an assumption is made that 3^{rd} party projections are provided on a weekly basis that include total season player fantasy point projections 221, total season player stat projections 223, weekly player fantasy projections 225 with the fantasy point projections being based on a set of default fantasy point scoring rules 227. The first set of steps to convert the 3^{rd} party player projections 221 into probability distributions usable by the season calculator 400 is to calculate a fantasy point normalization factor 229, calculate weekly player fantasy point projections 231 based on league specific scoring rules 233, calculate a standard deviation of the change of projections from the current week to the projected week for each player position 235, normalize the standard deviation of the change of projections from the current week to the projected week for each player 237 based on the normalization factor of league specific fantasy points versus 3^{rd} party fantasy points 239 due to the difference between the 3^{rd} party default fantasy point scoring rules 227 and the league specific fantasy point scoring rules 233, find the max fantasy point bin for each player position 241 and generate fantasy point probability distributions for each player for each week 243.

In another embodiment, the 3^{rd} party player projections 75 include projected season statistics for each player 223. For example, for a National Football League quarterback, the 3^{rd} party provides projections for pass completions, pass attempts, pass completion percentage, passing yards, passing touchdowns, interceptions, sacks and rushing yards. Total fantasy points for the season 221 are calculated from the projected season statistics for each player 223 using a set of default fantasy point scoring rules 227. In the same manner, league specific total fantasy points for the season are calculated from the projected season statistics for each player 223 using a league specific set of fantasy point scoring rules 233. For example, a 3^{rd} party scoring rule might be 0.04 fantasy points awarded per passing yard. However, the team manager's fantasy sports league might award 0.05 fantasy points per passing yard. If a particular quarterback in the league is projected to throw for 2388 yards for the season, this would contribute 95.5 (0.04×2388) fantasy points towards the 3^{rd} party's fantasy point projection but it would result in 119.4 (0.05×2388) fantasy points based on the league specific scoring rules. Each player stat multiplied by its scoring rule is summed together to make up the total player fantasy point projection. The fantasy point normalization factor for each player 239 is calculated by first calculating the league specific total fantasy point projection and then dividing by the 3^{rd} party total fantasy point projection for each player 221.

Weekly league specific fantasy point projections for each player 231 are calculated by multiplying the player's fantasy point normalization factor 239 by the player's 3^{rd} party weekly fantasy point projection 225.

The standard deviation of how much 3^{rd} party fantasy point projections change from week to week, STDpp, for each position 235 can be calculated from the 3^{rd} party projections of the previous season. It is assumed that one who is skilled in the art can make this calculation and for one embodiment STDpp is assumed to be a constant for each player position. Intuitively, the further out in time a projection is, the more it is likely to change before the occurrence of the actual event it represents. For example, player injuries, coaching changes, changes in performance of other players and player trades are less likely to affect player projections in the course of sixteen weeks than over a one week period. For each week, the STDpp for a one week span 243 is multiplied by the square root of the number of weeks out the projection is 245 to get the standard deviation of the change of that projection between the current time and the time of the projection 235. If the player projection is for the current week, then STDpp 243 does not apply. Instead, the standard deviation between week projections and actual results for the player position, STDpa 247 is used for calculating the normalized standard deviation 237 for each player probability distribution 249.

The league specific fantasy point probability distribution for each player position must use the same set of fantasy point bins, Data Type 2 241 for the following calculations. If the league allows a flex position (a starting position that can be filled with more than one player position, such as a running back or a wide receiver) then all player positions allowed for a single starting position must also share the same fantasy point bins, Data Type 2 241. The minimum bin is always zero. The maximum bin is the maximum projection for the position or flex position plus two times the maximum standard deviation 237 for the position or flex position.

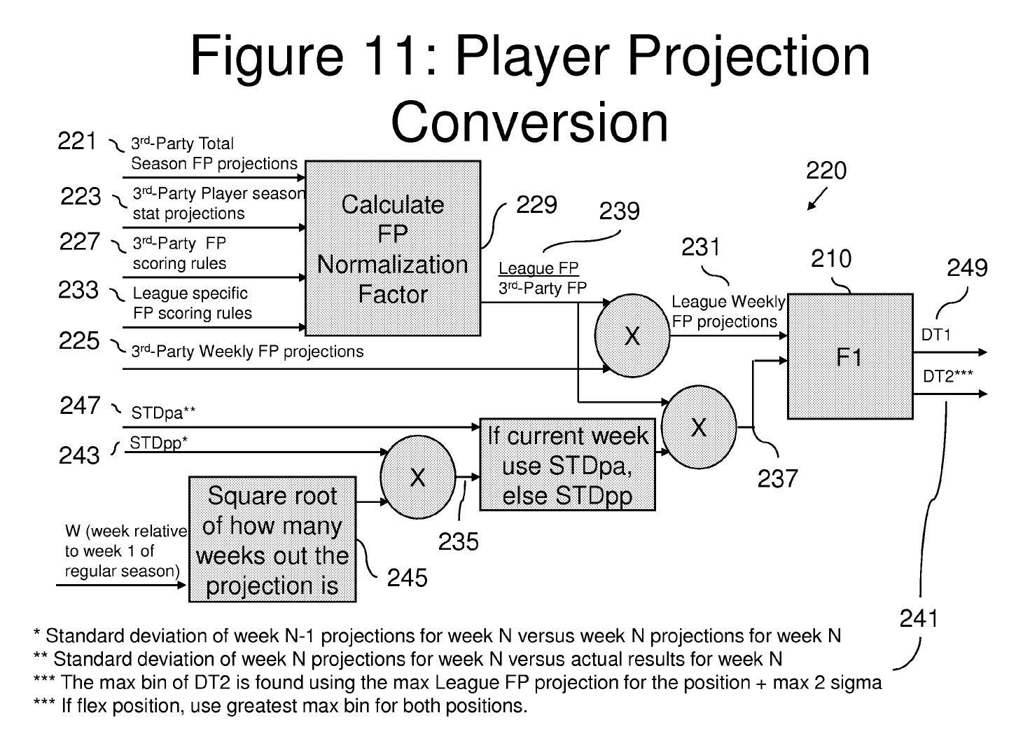

League specific weekly fantasy point player projections 231, the normalized standard deviation for each week for each player position 237 and the fantasy point bins for each position or flex position 241 (shown as a pass through in FIG. 11) are input into Function 1 210 for the first stage of calculating the league specific fantasy point player distributions, Data Type 1 249.

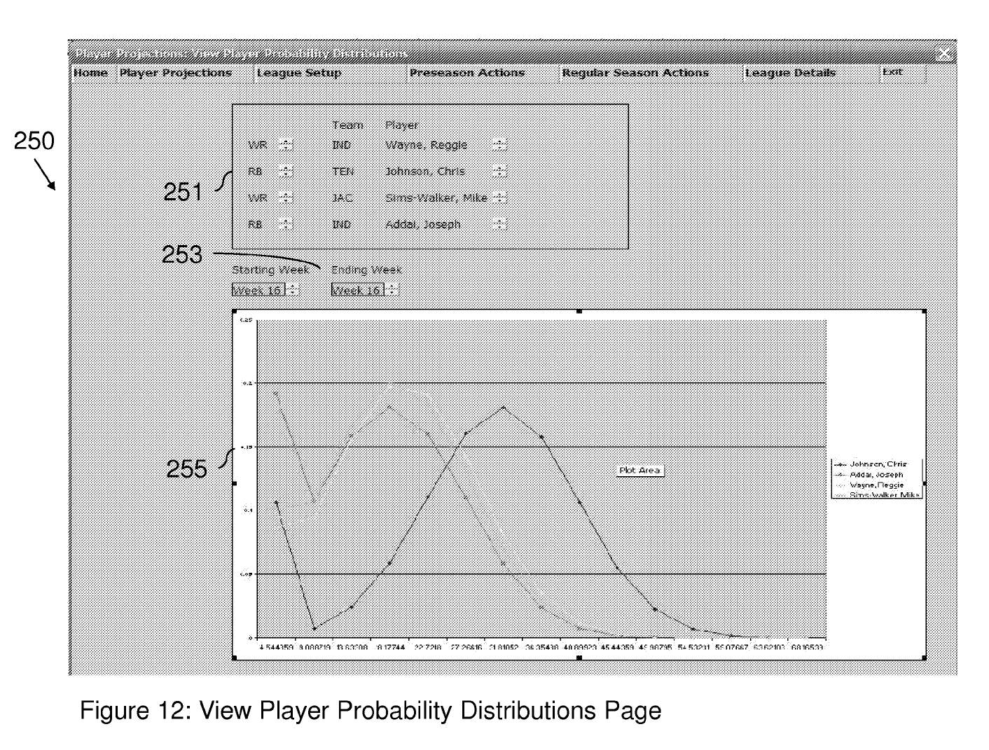

A View Player Probability Distributions page 250 shown in FIG. 12 enables the team manager to select players 251 and weeks of the season 253 and view the player probability distributions for the selected players and weeks 255. The probability distributions viewed on this page are modified from the output of the player projection conversion function 220 to account for the standard deviation of projections versus actual results, STDpa 247 and the probability of a zero fantasy point event, such as an injury. The method for performing this calculation is described in a subsequent description.

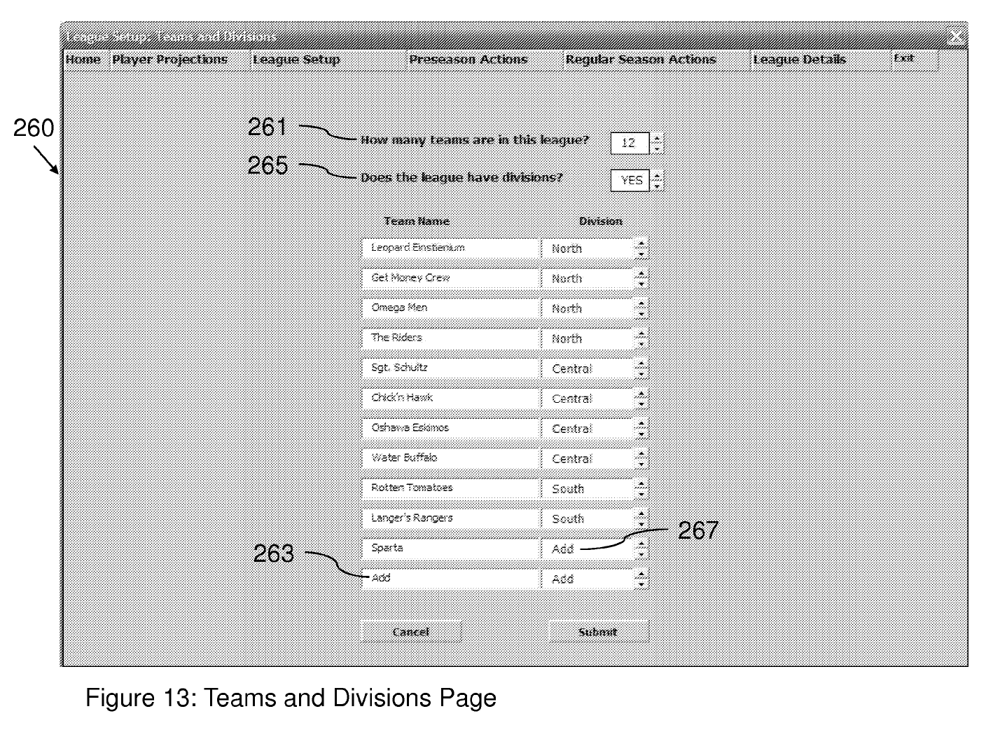

A Teams and Divisions page 260 shown in FIG. 13, enables the team manager to indicate the number of teams 261 and team names 263 in the league and whether the league has divisions 265 and if so the division names 267.

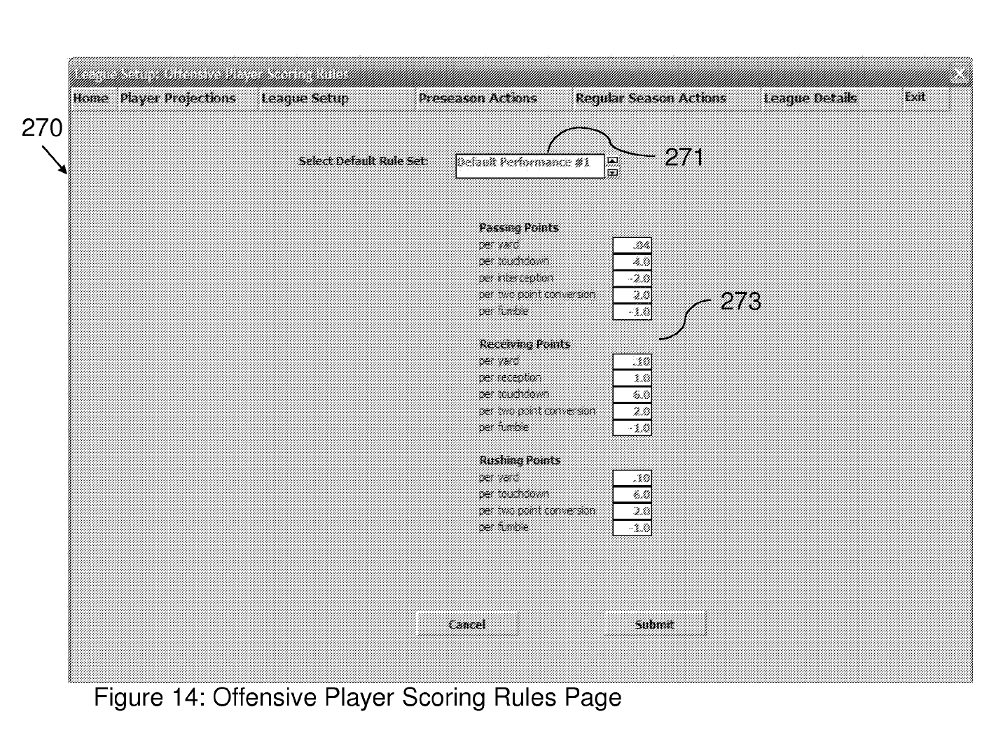

An Offensive Player Scoring Rules page 270 shown in FIG. 14, enables the team manager to select a predefined set of offensive player scoring rules 271 that most closely matches the league specific offensive player scoring rules and then to modify the rules 273 as needed to match the league specific scoring rules.

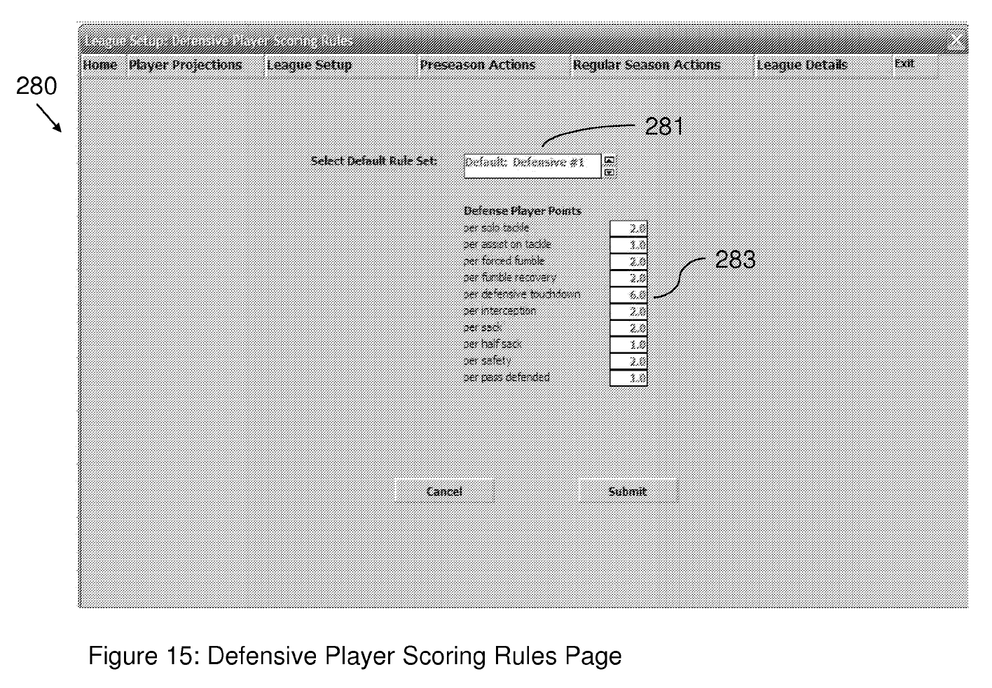

A Defensive Player Scoring Rules page 280 shown in FIG. 15 enables the team manager to select a predefined set of defensive player scoring rules 281 that most closely matches the league specific defensive player scoring rules that can also modify the rules 283 as needed to match the league specific scoring rules.

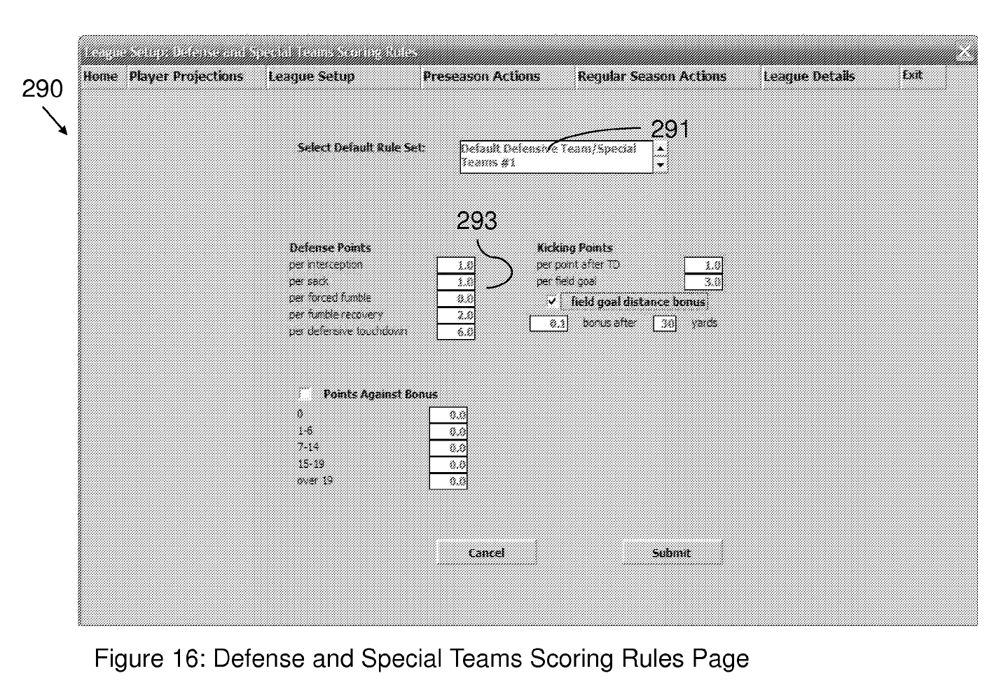

A Defense and Special Teams Scoring Rules page 290 shown in FIG. 16, enables the team manager to select a predefined set of defense and special teams scoring rules 291 that most closely matches the league specific defense and special teams scoring rules that can also modify the rules 293 as needed to match the league specific scoring rules.

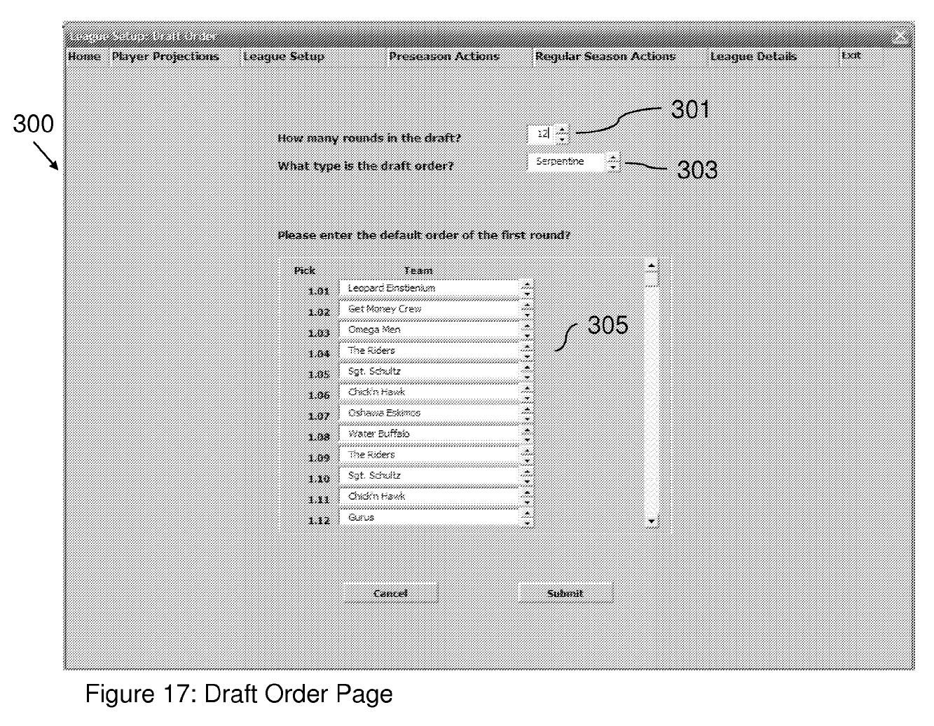

A Draft Order page 300 shown in FIG. 17, enables the team manager to select how many rounds there are in the league draft 301, if the draft order is serpentine or round-robin 303 and the default order (before trades) is from the first round 305. From the default information, a draft table is generated (not shown) and on another page, the team manager is able to modify each draft pick as necessary to reflect the result of any draft pick trades.

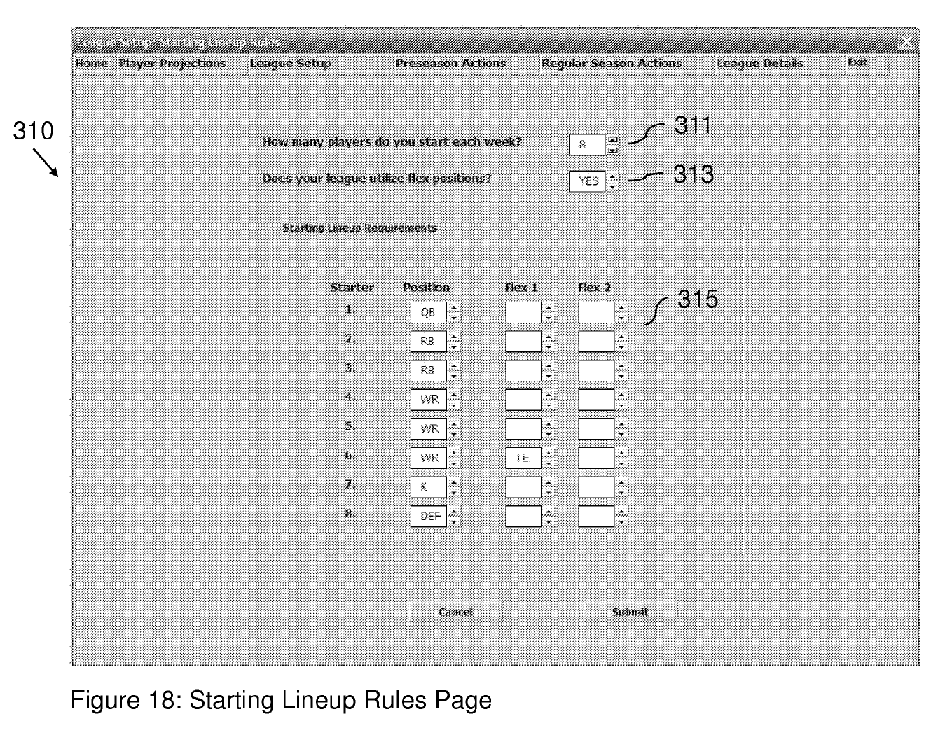

A Starting Line-up Rules page 310 shown in FIG. 18 enables the team manager to select how many players to start 311, if the league has flex positions 313 and if the player position rules fill a starting line-up 315.

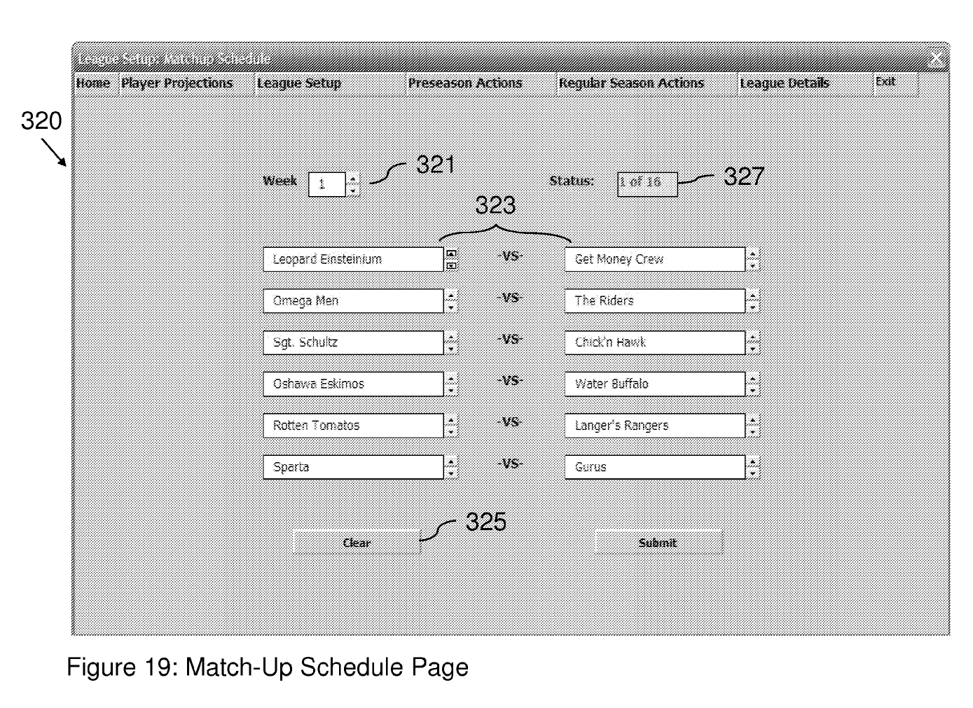

A Match-Up Schedule page 320 shown in FIG. 19 enables the team manager to indicate the match-up schedule for each week. The team manager selects the week 321 and then the match-ups for that week 323. As the team manager selects teams for the different match-ups, the selection options for each match-up are reduced to only include teams not selected yet. A clear button 325 is provided so the team manager can start over in case of a mistake. Also a status window 327 indicates how many weeks of the schedule have been filled out.

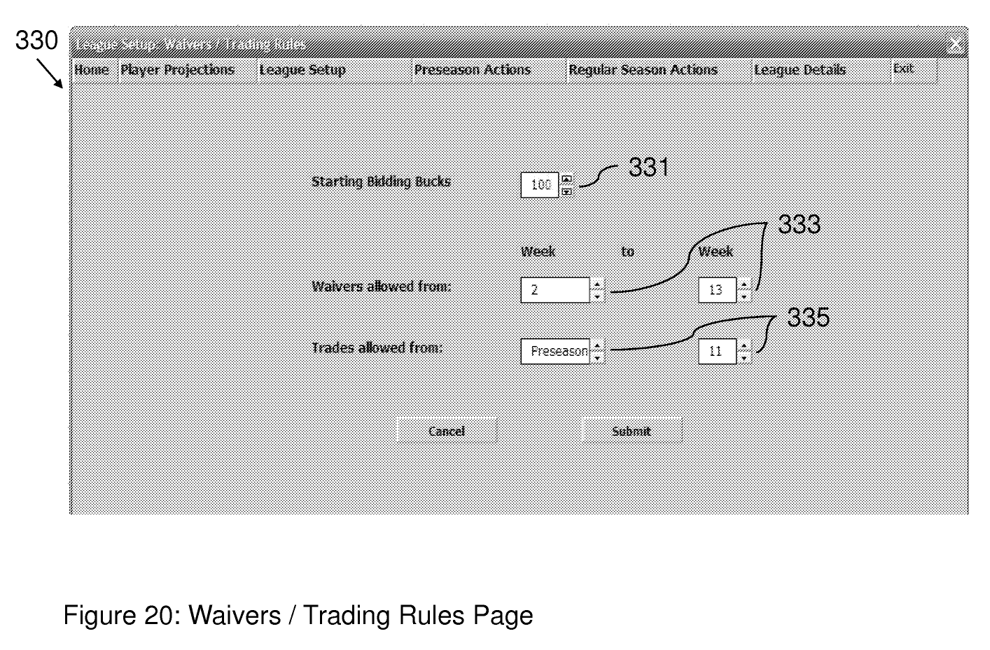

A Waiver/Trading Rules page 330 shown in FIG. 20, enables the team manager to select starting biding bucks 331, the starting and ending week for waivers 333 and the starting and ending week for player trades 335.

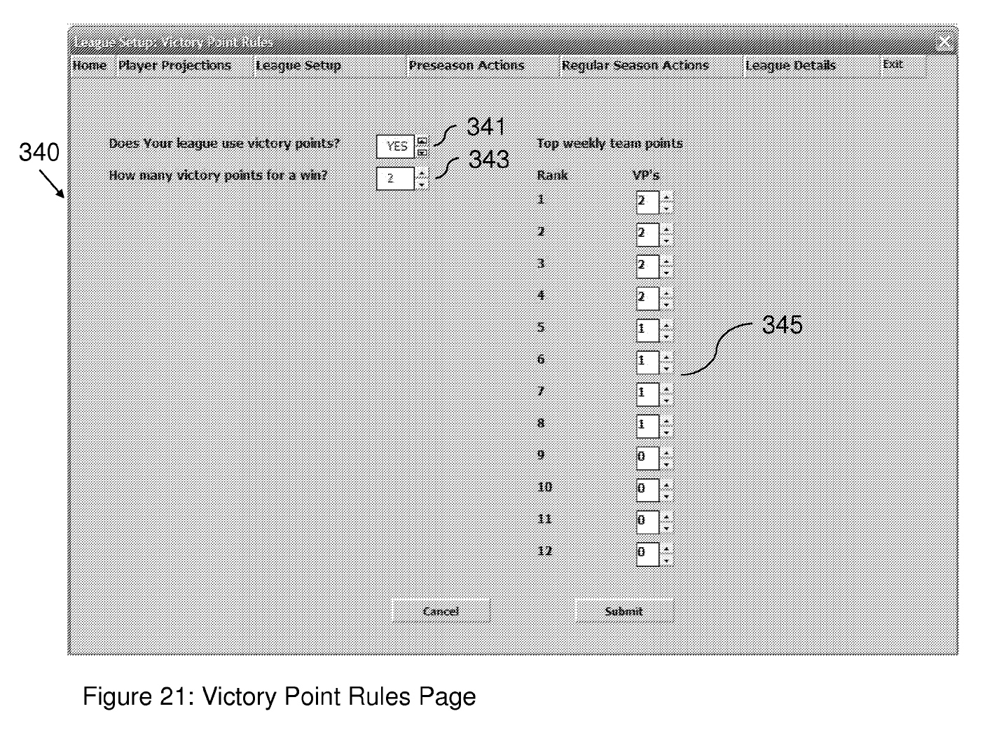

A Victory Point Rules page 340 shown in FIG. 21, enables the team manager to indicate whether the league uses victory points 341, how many victory points are awarded for a win 343 and how many victory points are awarded based on rank 345.

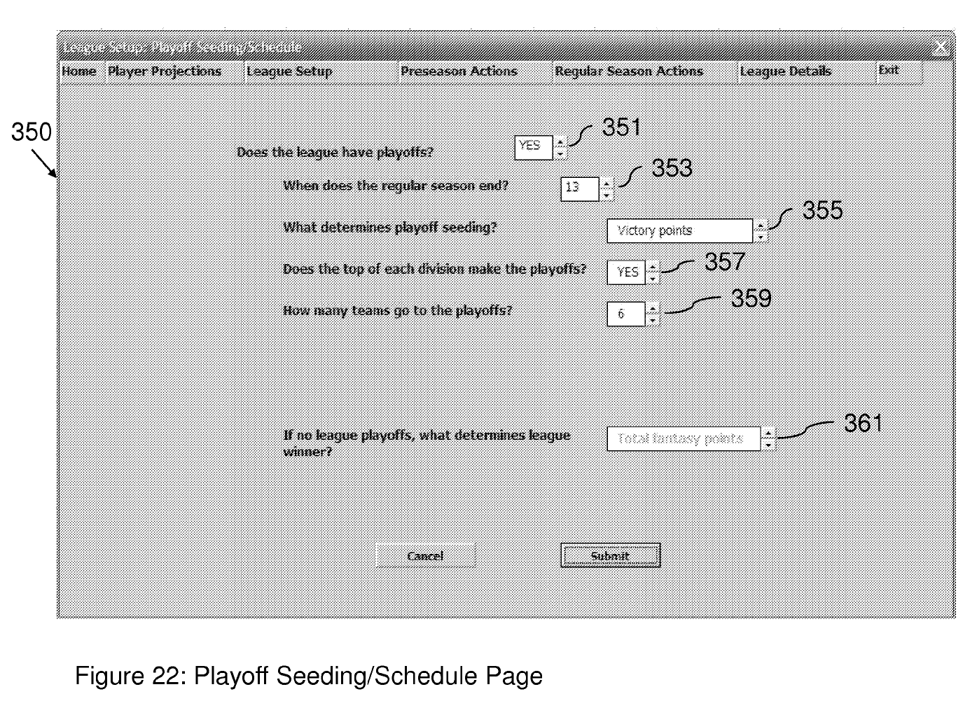

A Playoff Seeding/Schedule page 350 shown in FIG. 22, enables the team manager to indicate whether the league has playoffs 351, what week the regular season ends 353, how playoff seeding is determined 355, such as by victory points, win/loss record or total victory points, whether the top team of each division is guaranteed a playoff spot 357 and how many teams go to the playoffs 359. If the league does not have playoffs, then the team manager selects how the league champion is determined 361, such as by victory points, win/loss record or total fantasy points.

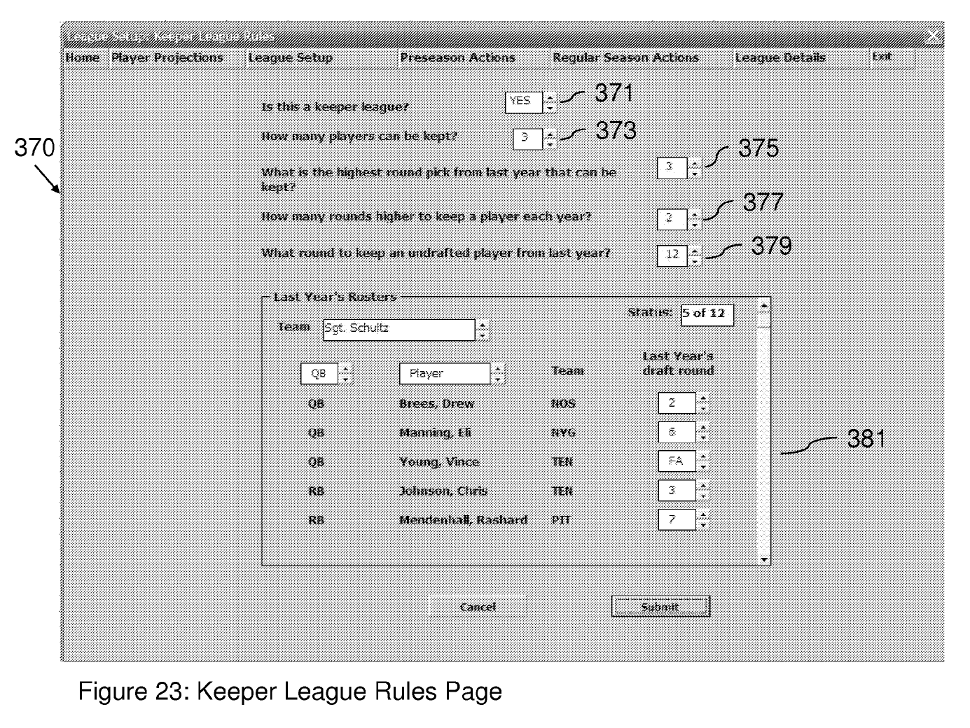

A Keeper League Rules page 370 shown in FIG. 23, enables the team manager to indicate whether the league has keepers (players that a team manager can keep on the roster from the previous season) 371, the maximum number of players that can be kept 373, the highest draft round pick from the previous year that can be kept 375, how many rounds higher a pick must be surrendered to keep a player from the previous year 377, what round pick must be surrendered to keep an undrafted player from the previous year 379 and the players from last year on each team roster 381.

Once the team manager set-ups up all league rules and schedules 65 and all 3^{rd} party projections 75 are modified to the team manager's liking 63 and the projections are converted to normalized probability distributions 249, the team manager can start to perform Preseason Tasks 67 accessed through the graphical user interface Preseason Action's pull down menu 107. Preseason Tasks usually involve transactions with partially filled team rosters. However in order to produce useful results, the season calculator 400 requires team rosters to be filled. In an exemplary embodiment, normalized player probability distributions 249 of unclaimed players are averaged together to generate pseudo players. For each position, the pseudo players are named based on their position and an integer such as QB1, QB2, QB3, etc. The method to create the pseudo players is to average existing players' probability curves together. For example, if there is a need to average ten quarterbacks (QBs), the probability for each bin for each quarterback would be added together and divided by ten to make a new probability curve that represents the average of the original ten. The number of players that are averaged together is equal to the number of teams in the league. Only unclaimed players are used for building the pseudo players. Any player that is on a roster is excluded from the averaging. The top unclaimed players of a position are used to make the first pseudo player of that position, and then the next set of top players is used to make the second pseudo players, and so on until all unclaimed players are used. If the last set of unclaimed players has fewer players than required for the next pseudo player, zeros are used to fill in the missing players required to make the pseudo player. For example, if for that last pseudo player of a position, ten players are required, but there are only seven remaining unclaimed players, then the seven probability distributions are added together, but the sum is still divided by ten. The pseudo players are generated as part of a projection conversion system 77.

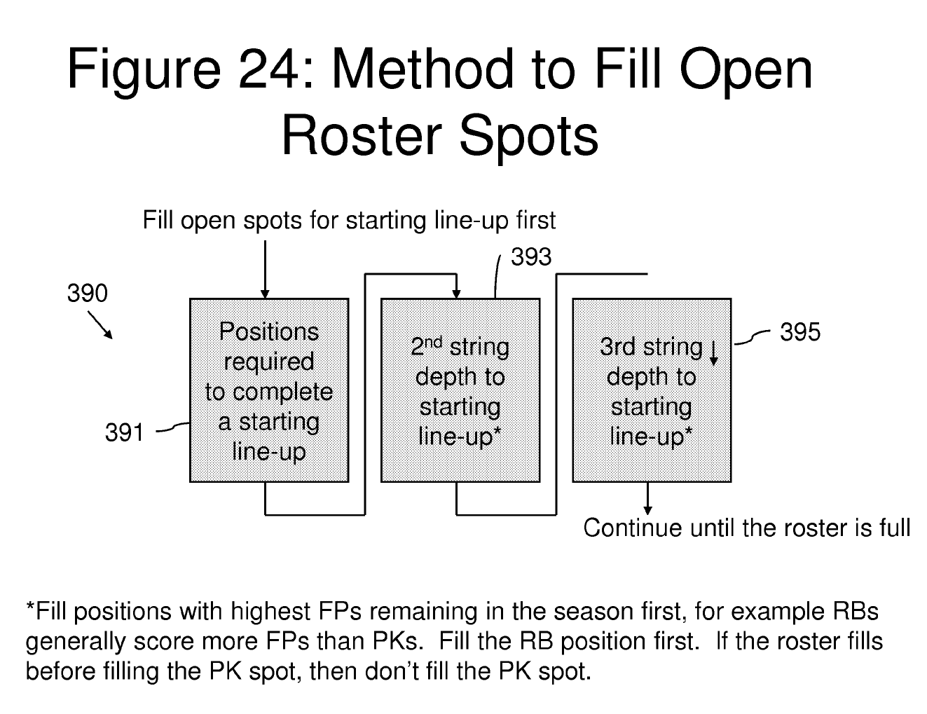

The team Rosters system 71 fills all empty roster spots on team rosters with the pseudo players. A pseudo player is used to fill roster spots differently than an actual player. An actual player is only available to one team roster. Since a pseudo player represents the average player available averaged by the number of teams in the league, a pseudo player is available for every team roster. FIG. 24 shows a flow diagram for filling a team's open roster spots with pseudo players 390. Roster spots are filled first to have a complete starting line-up 391, then a complete 2^{nd} string depth 393, then a 3^{rd} string depth 395 and so forth until the roster is full. For each level of starter and back-ups, the position of the pseudo player with the most fantasy points is filled next.

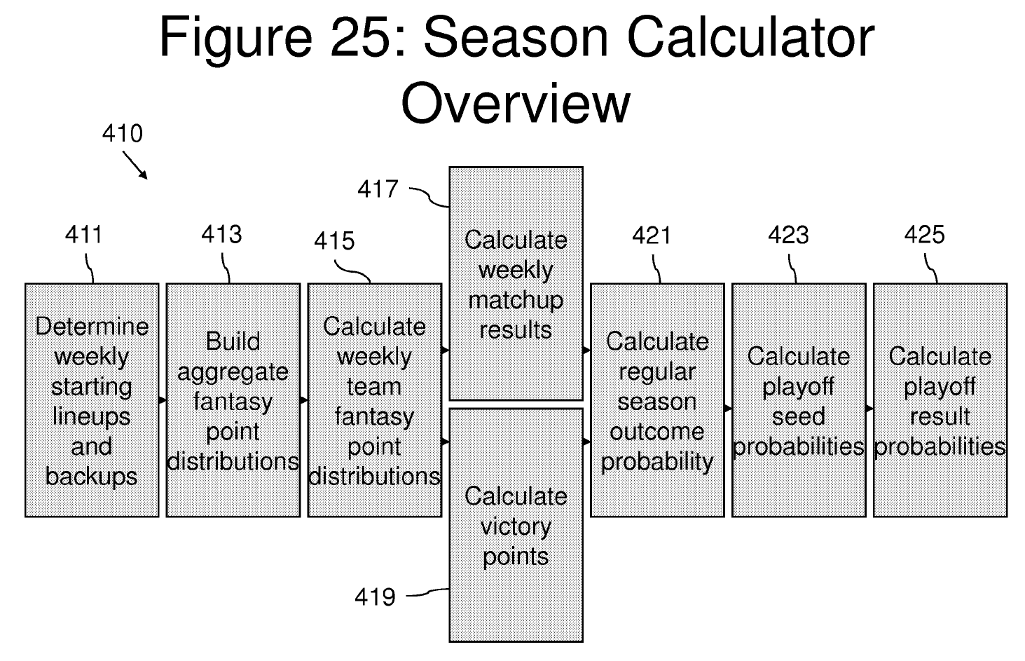

The purpose of the season calculator 400 is to evaluate possible league scenarios relative to the probability of winning a league championship. Different scenarios are possible as a result of potential transactions a team manager might carry out, such as deciding what players to keep, selecting draft picks, performing trades, etc. Scenarios for evaluation by the season calculator 400 are generated by the transaction generator 79 under the control of either the preseason's tasks 67 or the regular season tasks 69. The season calculator 400 utilizes information about the state of the fantasy league that includes league rules, such as divisions (if any), victory point rules (if any) and play-off seeding rules (if any), match-up schedule 65, team rosters 71, league set-up data 65 and player fantasy point probability distributions 77. Operation of the season calculator 400 might be described with reference to the flow diagram 410 in FIG. 25 which include determining weekly starting line-ups and back-ups 411, building aggregate fantasy point distributions 413, calculating weekly team fantasy point distributions 415, calculating weekly match-up results 417, calculating victory points (if any) 419, calculating regular season outcome probability 421, calculating playoff seed probabilities (if any) 423 and calculating playoff results (if any) 425.

Weekly starting line-ups and back-ups 411 are determined using the normalized weekly fantasy point projections for each player on the roster and pseudo-players 77. The starter for each position is the player with the highest fantasy point projections for that week. Single position starting spots are filled before filling flex positions. Once all starters are filled, back-up spots are filled for all weeks other than the current week. The first back-ups are filled first, then the second and third back-ups are filled until all players from the roster are used. This is similar to the method to fill open roster spots 380 of FIG. 24, except instead of filling team roster spots from available unclaimed players and pseudo players, the players are already on an existing team roster and are simply being organized as starter, back-up and second back-up, for each starting line-up position. An analogy is that filling open roster spots is like the NFL draft and organizing the players into starters and back-ups is like an NFL team depth chart. For the current week of the season, no back-ups are added to the starting line-up.

Aggregate fantasy point distributions are built in step 413. As a season progresses, players might be injured or other factors might come into play that improve or degrade a projected starter's or back-up's performance. The normalized fantasy point probability distributions 249 account for changes to projections by factoring in the standard deviation of projection changes from week to week via the STDpp 243. The purpose of building aggregate fantasy point distributions is to realize the value of back-up players in mathematically correct terms. A team may have the best quarterback in the league and this quarterback might have the highest fantasy point projection for each week in the season. However, having a back-up quarterback on the roster still has value because the starting quarterback might become injured or his performance might degrade because his best wide receiver might be traded to another team (for example). On the other hand, the back-up quarterback has some potential to surpass the starter in performance. This process for generating the aggregate fantasy point projections is computationally intensive and is implemented for efficiency. Also, results might be cached so that in subsequent evaluations provided by the season calculator 400, the same combinations do not need to be recalculated. Starting with the normalized projections distributions from the projection conversion 77, there are three steps to building the weekly aggregate fantasy point player distributions for players not in the current week: build Aggregate FP Player Stage 1 Projection Distributions, build Aggregate FP Player Stage 2 Projection Distributions and add zero FP event probability to the results distribution.

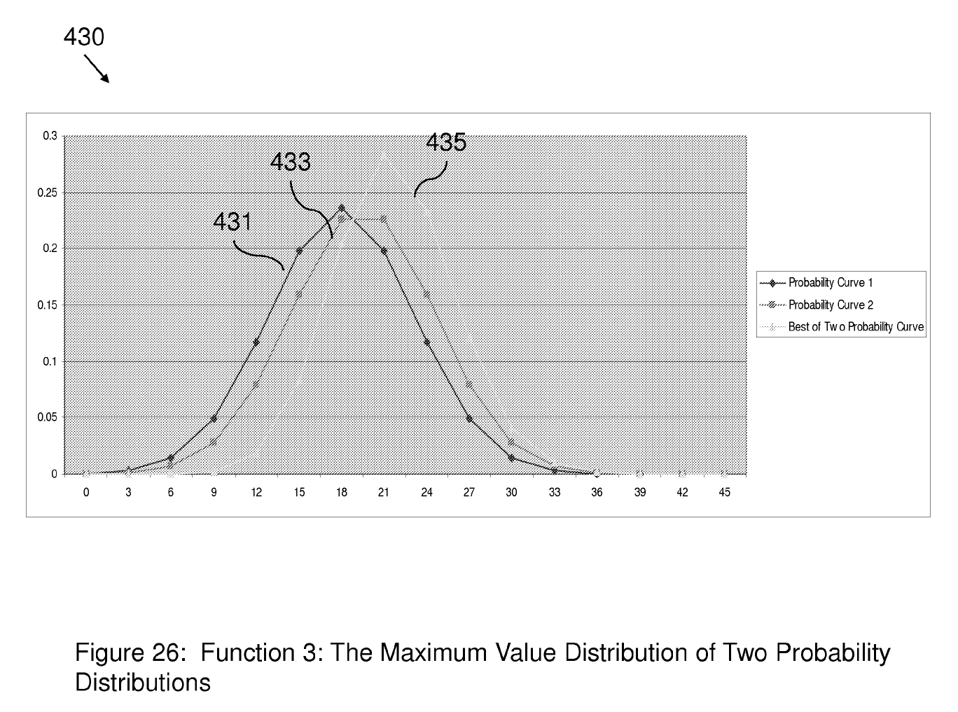

The method for building aggregate FP player Stage 1 projection distributions requires finding the maximum value probability distribution of two probability distributions as shown in FIG. 26 and referred here forth as Function 3. The input to Function 3 is the two player probability distributions from Data Type 1, such as the normalized fantasy point player distributions 249 from the projection conversion 77. Projection bin values Data Type 2 241 are not used, except that both inputs must have the same bin values and the outputs inherit the same bin values as the inputs. The function starts with the first bin and calculates the probability that both players will have new projections in that bin. That is the probability that the new projection will have a maximum value in the first bin. The function then calculates the probability that both players will have new projections within the first two bins and subtracts the probability of the maximum value being in the first bin, which is the probability the new projections will have a maximum value in the second bin. This continues for all bins creating a new probability distribution that is shifted right, compared with the two input distributions. FIG. 26 shows a graph of two input normal distributions 430, one with a mean of 18 and a standard deviation of 5 431, the other with a mean of 19.5 and a standard deviation of 5 433 and an output curve that is shifted to the right with a higher peak 435.

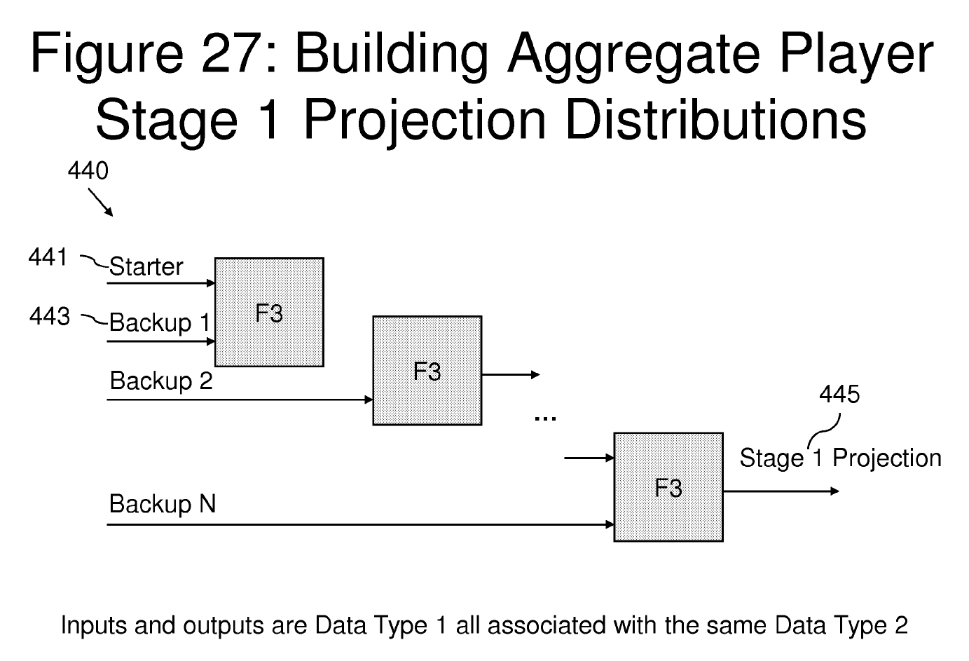

FIG. 27 shows the flow diagram 440 for building aggregate FP player Stage 1 probability distributions using Function 3. At this point, the fantasy point distributions for weeks other than the current week only represent change in the projections due to STDpp 243, not the accuracy of the projections compared with actual results represented by STDpa 247. First the probability distributions for the starter 441 and the top back-up 443 for a starting position are combined using Function 3, then the probability distribution of the next back-up is combined using Function 3. The final aggregate FP player Stage 1 probability distributions 445 represent the value of the starting player and all back-ups for a starting line-up position.

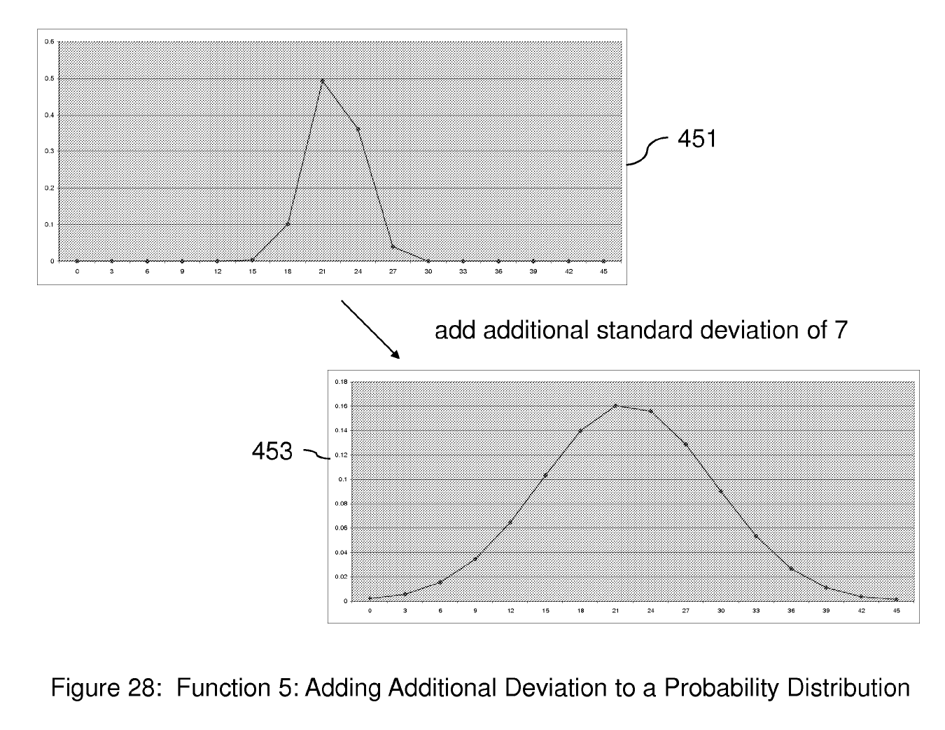

The method for building aggregate FP player Stage 2 projection distributions requires adding additional deviation to the Stage 1 projections to account for the accuracy of player projections versus actual results. Until now deviation for all weeks except the current week, reflect only the deviation of the projections themselves from the week to week STDpp 243, not the accuracy of the projections versus the actual results STDpa 247. From here forth, the function for adding additional deviation is referred to as Function 5. The inputs to Function 5 are a probability distribution, Data Type 1 associated probability bins, Data Type 2 and a standard deviation derived from STDpa 247. In an exemplary embodiment, the output distribution is generated by creating sixteen normal distributions per Function 1, each with a mean centered on each of the sixteen bins and the input standard deviation. Then each point of each of the sixteen normal distributions is multiplied by the probability of its mean value in the input probability distribution. Then the probabilities of all sixteen probabilities in each bin are summed together to get the probability for the output of the same bin. FIG. 28 shows the input graph 451 for a normal distribution with a mean of 22, a standard deviation of 2 451 and an output graph 453 showing the result of adding a standard deviation of 7 to the probability distribution input.

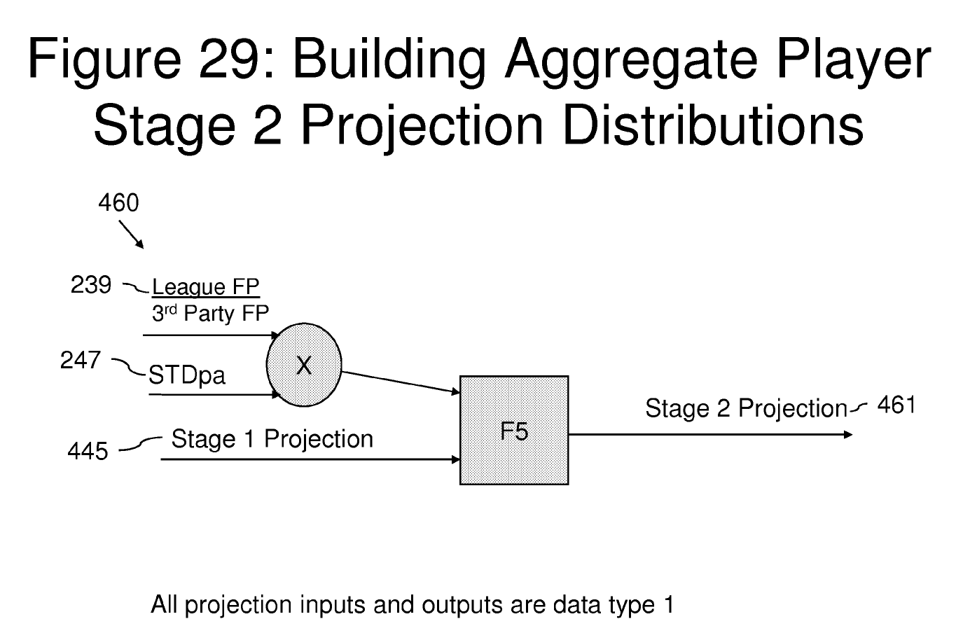

FIG. 29 shows a flow diagram for building aggregate FP player Stage 2 projections 460. The Standard deviation of 3^{rd} party player projections versus actual results STDpa 247 is multiplied by the league fantasy point normalization factor 239 and is used as the standard deviation input to Function 5 for each player position. The Stage 1 projections 445 provide the probability distribution input to Function 5 and the output provides the aggregate FP player Stage 2 probability distributions 461.

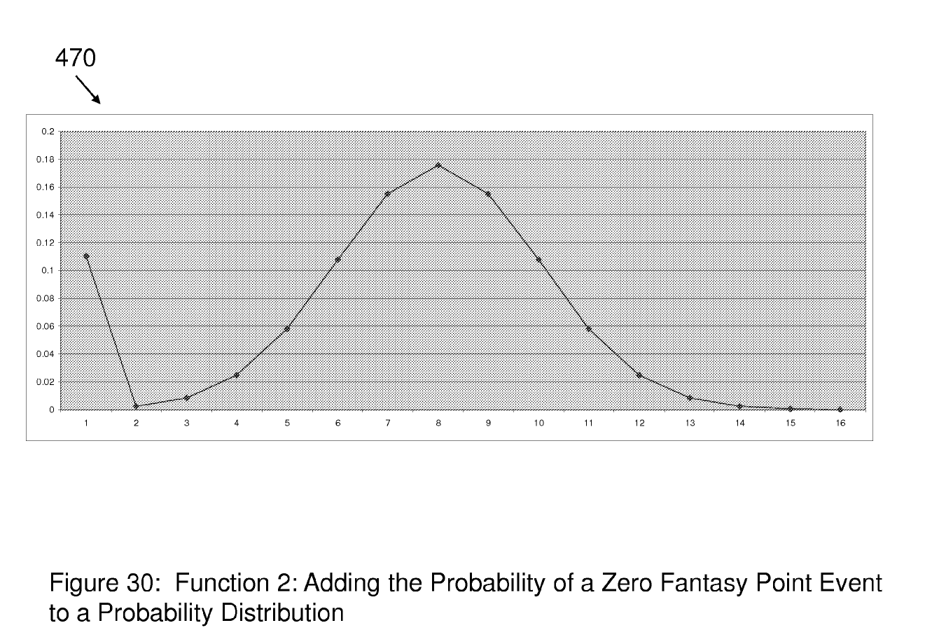

The final step for building aggregate fantasy point distributions is to add to the probability that events not accounted for, such as injury, suspension and so forth, will occur that result in zero fantasy points to the aggregate FP player Stage 2 probability distributions 461. The function for adding the probability of a zero fantasy point event to a probability distribution is referred to as Function 2 here after. The inputs to Function 2 are the probability of a zero fantasy point event, a probability distribution, Data Type 1, where the first bin is 0. The output is generated by reducing all the Data Type 1 inputs proportionally by the probability of the zero fantasy point event and then adding the probability of the zero fantasy point event, PZ, to the probability of the first bin, p0. The probability of the first bin is p0(1−PZ)+PZ and the probability for all other bins is pN*(1−PZ). FIG. 30 shows a graph 470 of the output of Function 2 when adding a probability of a zero fantasy point event of 0.11 to the probability distribution 453 shown in FIG. 28.

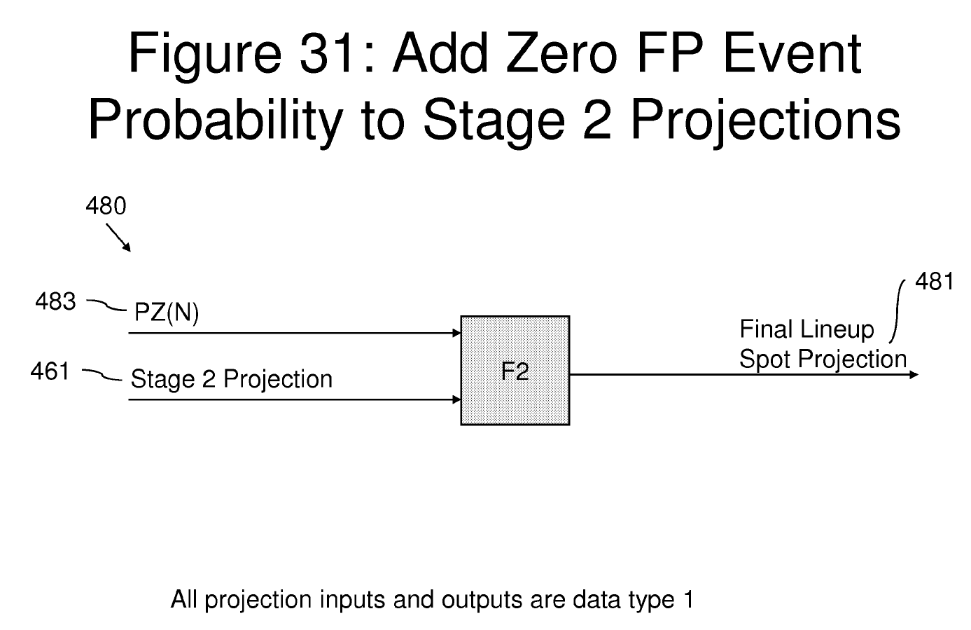

FIG. 31 shows a flow diagram 480 for building the final probability distribution for each starting line-up spot 481. It is certain that the probability of zero fantasy point probability events build cumulatively the further out in time a projection is made. A person skilled in the art could calculate the probability of a zero fantasy point event after a large span of time, such as fifteen weeks, based on historical projection data and actual results. The probability for a shorter one week period could then be derived from the greater time period. PZ(1) is used to denote the probability of a zero FP event one week from the current week. The method to calculate the probability of a zero FP event N weeks out from the current week is PZ(N), 483 is PZ(N)=1−(1−PZ(1))̂N.

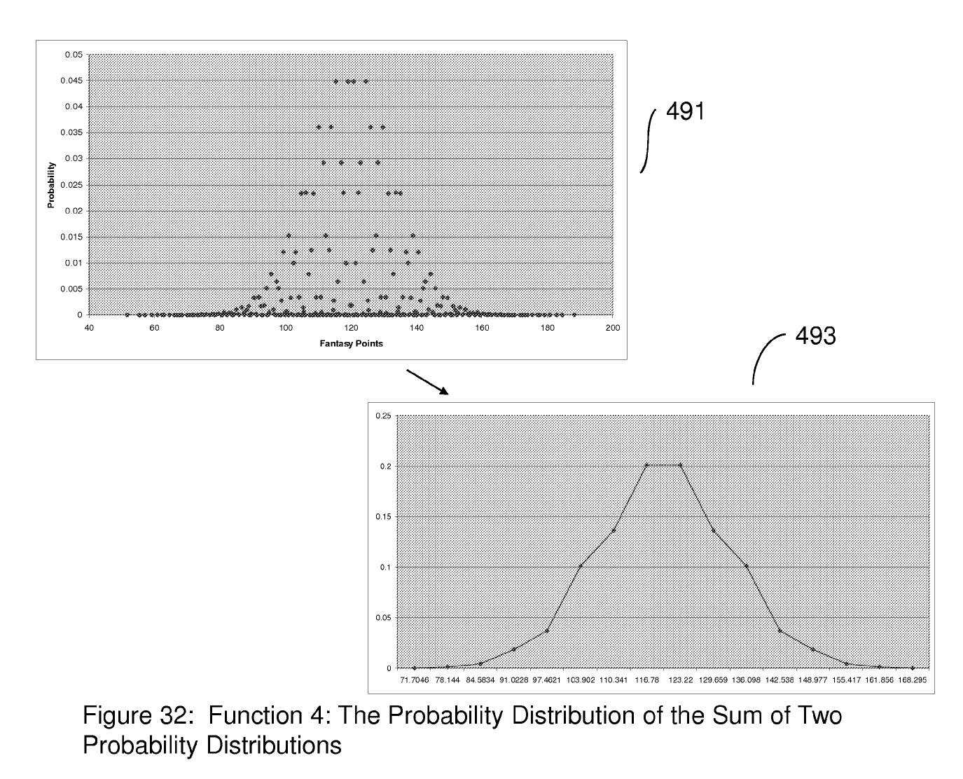

The next step of the season calculator 400 as shown in flow diagram 410 is to calculate the weekly team fantasy point distributions 415. A probability function, referred here after as Function 4, is used for finding the probability distribution of the sum of two probability distributions. The inputs to Function 4 are two probability distributions, Data Type 1, and their associated probability bins, Data Type 2. The probability bins do not need to be the same for both probability distributions. The output is a single probability distribution and its associated probability bins. There are three steps for calculating the output, calculate the probability bins, Data Type 2, of the output, create sixteen intermediate probability distributions and bins by multiplying each point of the first probability distribution with each point of the second probability distribution and summing the associated bin values of the first and second input, resulting in 256 points of data, each of which include a probability and a bin value as shown on graph 491 in FIG. 32, and distribute each point of the sixteen intermediate probability distributions into their respective output bins and sum the probabilities together within each bin to create a final output probability distribution of Data Type 1, as shown on graph 493 also in FIG. 32.

For the first step, the minimum value for the output probability bins, Data Type 2, is calculated with the following formula: B1mean+B2mean−(B1mean+B2mean−B1min−B2 min)/sqrt(2), where B1mean is the mean bin value of input 1, (B1min_B1max)/2 and B2mean is the mean bin value of input 2, where B1 min is the minimum bin value of input 1 and B2 min is the minimum bin value of input 2. The maximum value for the output probability bins, Data Type 2, is calculated with the following formula: B1mean+B2mean+(B1max+B2max−B1mean−B2mean)/sqrt(2), where B1 mean is the mean bin value of input 1 (B1min_B1max)/2, B2mean is the mean bin value of input 2, B1max is the maximum bin value of input 1 and B2max is the maximum bin value of input 2. Points two through fifteen of the output probability bin values, Data Type 2, are calculated by evenly distributing the difference of the minimum and maximum bins across all bins. FIG. 32 shows the output distribution 493 for an input with a minimum bin value of 40 and a maximum bin value of 120, Data Type 2, and a normal probability distribution, Data Type 1, with a mean of 80 and a standard deviation of 8. The second input has a minimum bin value of 11.7 and a maximum bin value of 68.3 and a normal probability distribution with a mean value of 40 and a standard deviation of 8.

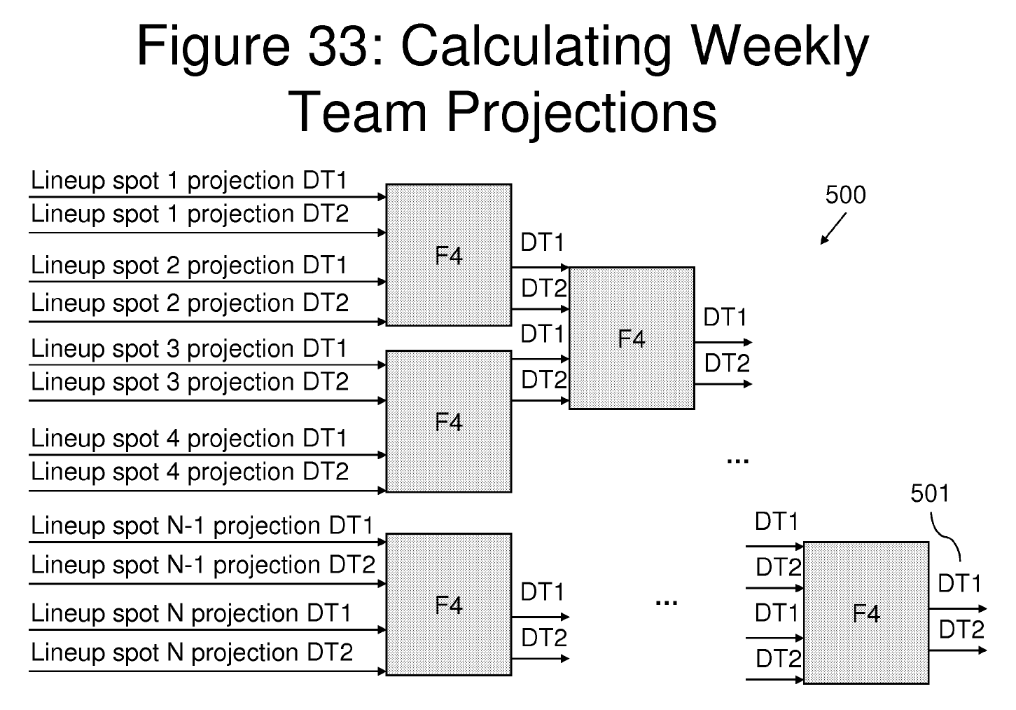

FIG. 33 shows a flow diagram 500 of how Function 4 is cascaded to calculate a single weekly team projection 501 from each final line-up spot projection 481.

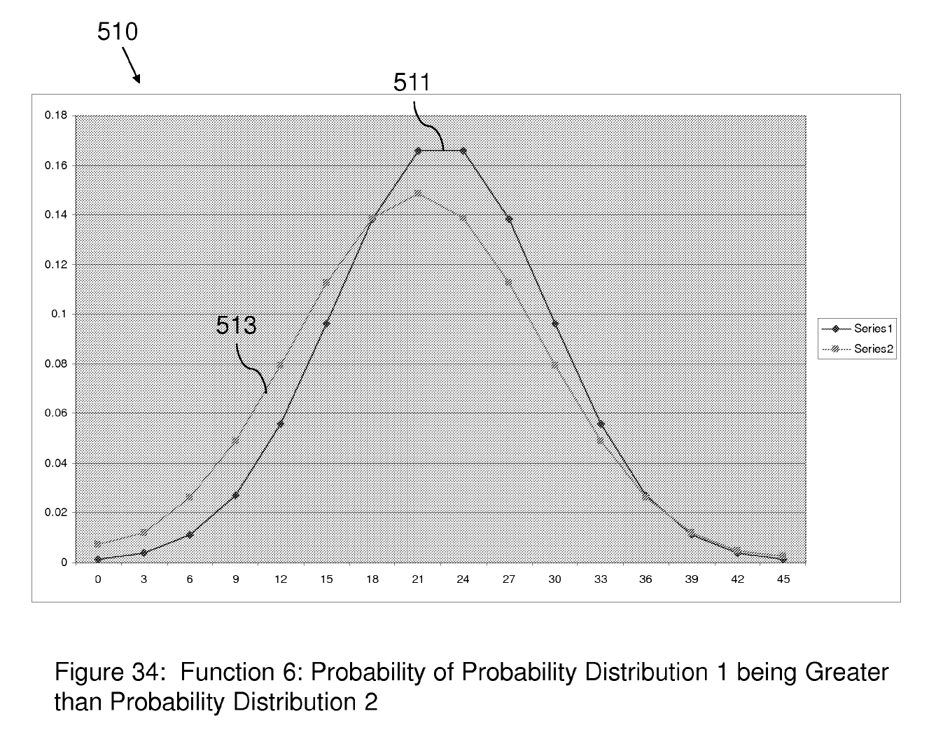

Once the weekly team projections 501 are calculated, it is then possible to calculate the probability one team will beat another team. A probability function, referred here after as Function 6, is used for finding the probability that the actual outcome represented by one probability distribution will be greater than the actual outcome represented by a second probability distribution. The inputs to Function 6 are two probability distributions, Data Type 1, with the same bin values, Data Type 2. The output is the probability that the actual outcome represented by the first probability distribution will be greater than the actual outcome represented by the second probability distribution. The output of Function 6 is calculated by integrating the probability that the first probability distribution is greater than the second probability distribution for each probability bin. For each probability bin, the probability that the second probability distribution is less than the mid-point of the bin is subtracted from the probability that the first probability distribution is greater than the mid-point of the bin. Then the difference is multiplied by the probability that the second probability distribution falls within the bin. Finally 0.5 is added to the sum of the product for each bin to yield the output of Function 6. FIG. 34 shows a graph 510 of two probability distributions where the first probability distribution 511 is a normal distribution with a mean of 22.5 and a standard deviation of 7 and the second 513 is a normal distribution with a mean of 21 and a standard deviation of 8. The output of Function 6 for these two probability distributions is 0.55 indicating that there is a fifty five percent (55%) probability that the actual outcome represented by the first probability distribution will be greater than the actual outcome represented by the second probability distribution.

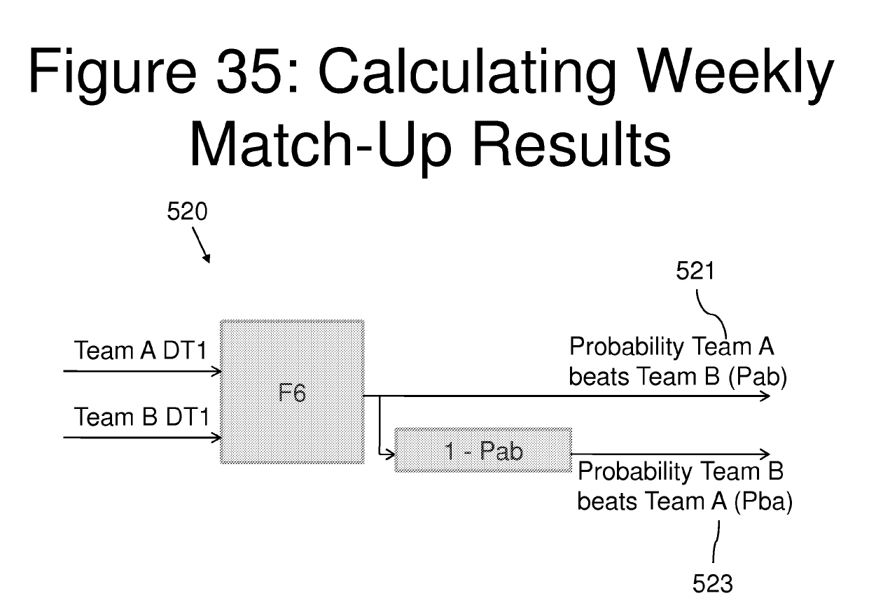

Weekly match-up results are calculated at step 417. FIG. 35 shows a flow diagram 520 of how Function 4 is used to calculate the probability that team A will win a match-up against team B 521 and vice-versa 523. The match-ups are based on the season schedule.

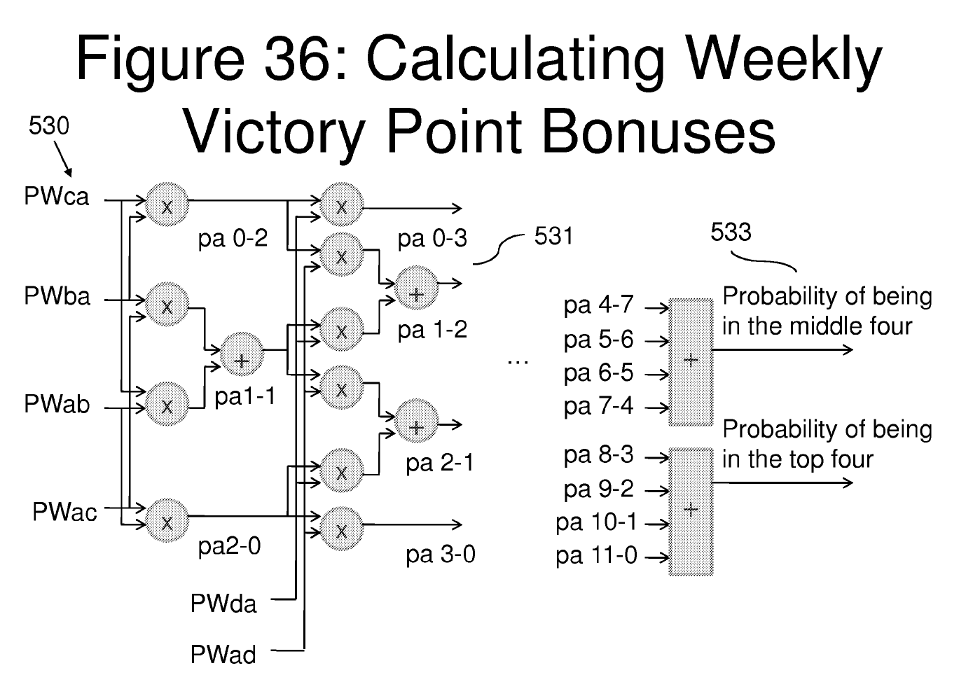

Victory points are calculated at step 419. If the league uses victory points, then the probabilities of achieving a win for each team should be multiplied by the number of victory points awarded for a win. FIG. 36 shows a method 530 for calculating victory points associated with a weekly rank of a team's total fantasy points. If the league uses victory points, then every combination of every match-up is calculated for every team for all remaining weeks using the method for calculating weekly match-up results 520. Then for each week, a probability tree of wins and losses relative to the other teams in the league that week is calculated 531. Finally the sum of all of the outcomes that match a particular victory point bonus are multiplied by the victory point bonus 533. For example, in a twelve team league, if there is a victory point bonus of two points for being one of the top four high scorers and a victory point bonus of one point for being one of the middle four scorers, then the probabilities of the probability tree for all outcomes of winning eight or more match-ups should be multiplied by two and summed with the outcomes of winning four to seven match-ups. The two products are then summed producing the probable victory points the team will achieve and are then added to the victory points calculated for winning the weekly match-ups.

The regular season outcome 421 is calculated using a similar probability tree as for calculating the probability of team rank each week 531, except that instead of the probability of all match-ups for a single week, the input is the probability of winning each match-up in the regular season. This creates an array of probabilities each indicating a possible win/loss record that also adds up to a total of one. This array of probabilities can be turned into Data Type 1, where each bin represents an increasing win/loss record. If the regular season has slightly more than sixteen games, then the lowest probabilities of the lowest win/loss records can be combined. If the regular season has many more than sixteen games, such as with baseball or basketball, than a Data Type 2 can be associated with the distribution of win probabilities such that each bin represents a range of win/loss records.

In leagues that have playoffs, there might be three methods for calculating playoff seed probabilities 423, one based on total fantasy points, one based on team win/loss record and one based on victory points. Seeding based on total fantasy points is performed by building total season fantasy point distributions by extending the function of the calculating weekly team fantasy point distributions 500 to include all line-up spots for all weeks of the season. Then the whole season team rank is calculated in the same manner as the weekly team rank is calculated for a victory point bonus 530. A seeding based on a team's win/loss record is performed using the same method of calculating weekly match-up results 520, except the inputs are the probability distributions produced by the regular season outcome calculation 421. The result of each match-up of season records is then used to calculate the whole season team rank in the same manner as a weekly rank is calculated for a victory point bonus 530. The method for calculating playoff seeding based on victory points is the same as for calculating based on record except that the bin values, Data Type 2, must be adjusted to match the range of possible victory point outcomes for the league. For all three methods, if the league has divisions, then a ranking may be performed first within the divisions, then across the divisions so that the top team in each division is guaranteed a seed into the playoffs.

The final outcome of the season calculator 400 is the probability that each team wins the championship. For leagues that have playoffs, the final step of the season calculator is to calculate playoff result probabilities 425. Using the playoff seed probability calculated at step 423, all possible team match-ups results are calculated as in step 417. Then for each team, the probability that it wins a particular playoff game is a function of three sets of probabilities, the probability of being one of two seeds of the playoff game or being promoted to the match-up from the previous week, the probability of each of the other teams being the opposing team to match-up against and the probability of winning the match-up against each possible outcome. The sum of all combinations of products of those three sets of probabilities is the probability a team wins a particular playoff game.

In summary, the season calculator 400 uses probability distributions to model and simulate an entire fantasy sports season based on league specific rules. The season calculator 400 has several unique features that enable the overall invention to provide team transaction recommendations relative to the team's overall probability to win a league championship. The features include:
Creating player fantasy point distributions from fantasy point projections based on the collection of statistical deviation information;
Converting player fantasy point projections and annual statistics based on one set of scoring rules into player fantasy point projections based on league scoring rules;
Correctly handling and separating the deviation of projections over time versus the deviation of projections versus actual results;
Creating pseudo-players by averaging projections of undrafted players to completely fill in empty roster spots for transaction analysis during the preseason, such as during the draft;
Creating team fantasy point probability distributions for all games;
Evaluating the probability of a team to win each of its match-ups based on the actual league schedule;
Calculating the probability of a team to achieve each possible play-off seed based on season results up to a certain time and on projections going forward from that time;
Calculating the probability of a team to win the final championship game based on play-off seeding probabilities and match-up win probabilities; and
Calculating alternate or modified methods of playoff seeding probabilities and season results based on victory points, win/loss record, or total fantasy points and league divisions and whether the league has playoffs or if the winner is decided based on regular season results.

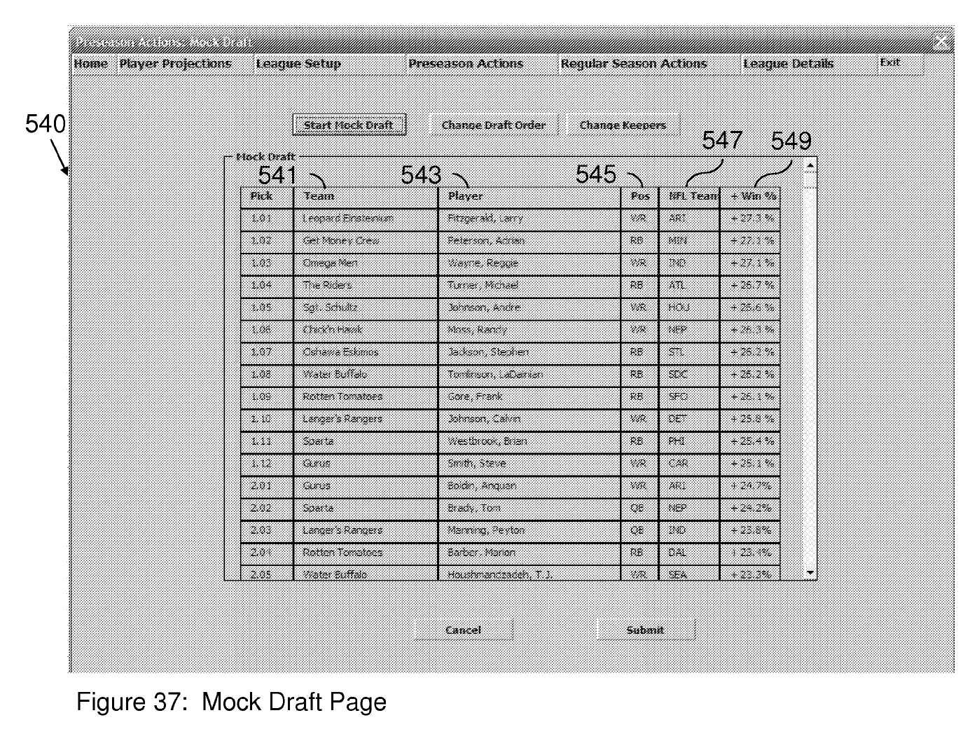

A Mock Draft page 540 shown in FIG. 37, enables the team manager to view a quick mock draft based on league specific set-up and probability simulation with the season calculator 400. The method for performing a mock draft comprises the following steps, run the season calculator 400 including using pseudo players for all unfilled roster positions, record the probability for the team that is on the clock to win the championship, add the top player for that position (once for each player position) to the roster of the team that is on the clock and rerun the season calculator, including recalculating pseudo players, record the new probability for the team that is on the clock to win the championship, select the player that improved his team's probability to win the championship, move to the next draft pick and repeat these steps until the draft completes. As the mock draft runs, the team manager is able to view what team is making a pick 541, the player selected 543, the position of the player 545, the professional team of that player 547 and the probability of a team to win the championship immediately after making a selection 549. The improvement a team realizes toward winning the championship is recorded as a means for valuing keepers. After the mock draft is completed, a zero is added to the set of improvements realized by each draft pick. The list is sorted from largest improvement to smallest and adjusted upwards as necessary to remove any negative numbers. Then the zero, which is now last in the list, is removed from the list. The list of improvements for each draft pick are summed together and then normalized so they add up to 1. The normalized list is now the value to use for each draft pick for the purpose of calculating keeper value. Now the value of the pick where each keeper was taken minus the value of the pick that must be surrendered for the keeper is an initial value of the potential keeper.

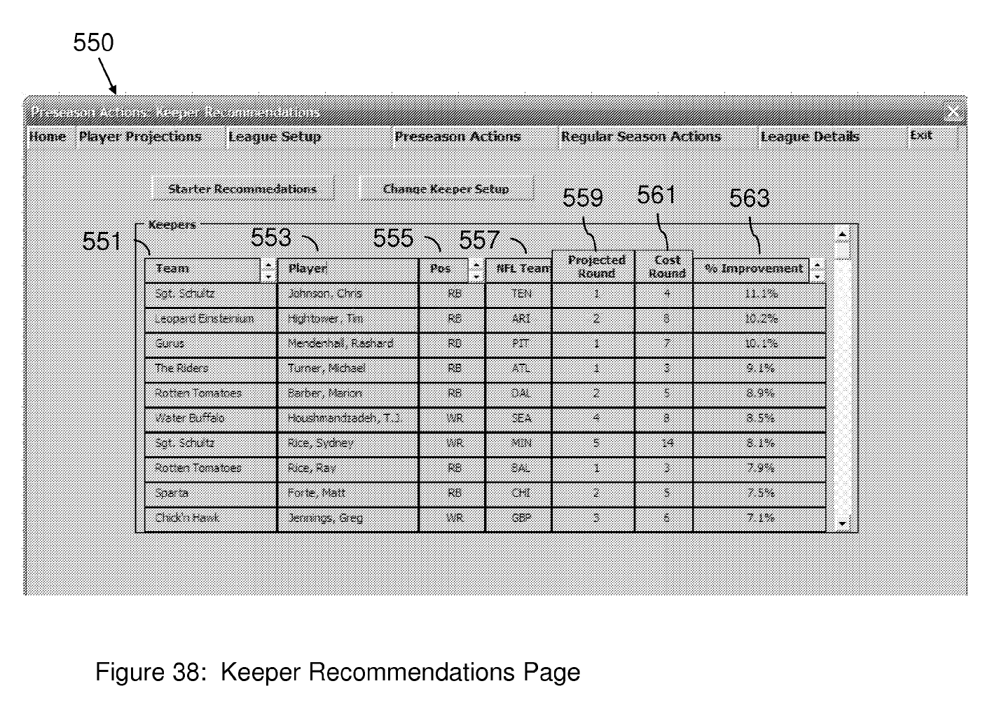

A Keeper Recommendations page 550 shown in FIG. 38 enables the team manager to view the value of potential keepers based on a league specific set-up and probability simulation with the season calculator 400. The method for calculating keeper value comprises the following steps, using the keeper data generated by the mock draft, assume the keeper of the greatest value is kept and place the selection of this player into the draft at the pick required by the team he belongs to, record the team's probability of winning the championship based on the previous mock draft, rerun the mock draft and record the team's new probability of winning the championship based on the new mock draft results, record the difference to the team's probability of winning the championship before and after selecting the keeper as the actual value of the keeper, find the keeper with the next greatest initial value from the previous mock draft results and repeat the steps until there are no potential keepers with positive value. As the above steps run to determine potential keepers, each potential keeper is shown on the Keeper Recommendation page 550, including the team it belongs to 551, the name of the keeper 553, the position of the keeper 555, the professional team of the keeper 557, the round the keeper would normally go in based on the mock draft 559, the round of the pick for which the keeper can be kept 561 and the value of the keeper 563. After there are no more potential keepers with positive value, keepers with negative value are added to the end of the list based on the result of the last mock draft run. Although a keeper has a negative value to the team he belongs to, he might have a positive value to another team.

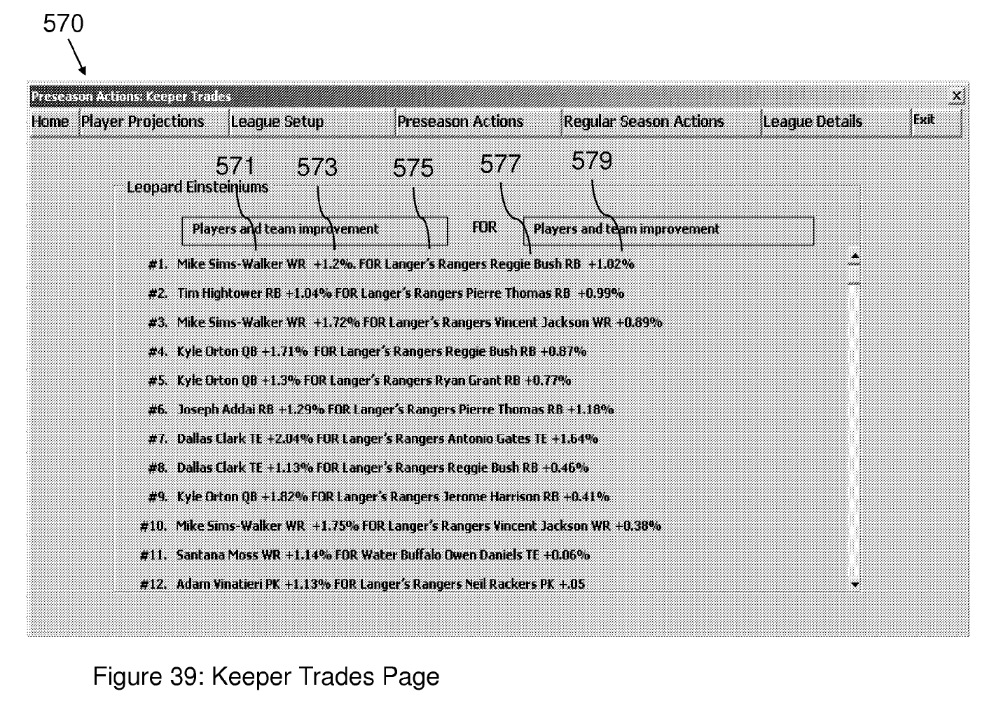

A Keeper Trades page 570 shown in FIG. 39 enables the team manager to generate and view recommended keeper trade proposals. Two types of keeper trades recommendations are generated, keeper for keeper trades and/or keeper for draft pick trades. The keeper for keeper trades are for exchanging keepers that have more value on one team than another based on the other keepers and draft picks of each team. For example, a team with two potential quarterback keepers, might benefit by trading one potential quarterback keeper for a potential tight end keeper with a team that has two potential tight end keepers. The keeper for pick trades are for when one team has more players with keeper value than is allowed to be kept and another team lacks the maximum number of players with good keeper value. In this case, a typical trade for mutual benefit involves trading the keeper player from the former team to the later team in exchange for trading picks, such that the former team improves draft pick value by half of the keeper value. Thus the value of the keeper now benefits both teams by half, whereas prior to the trade, it had no value to either team. The method for generating keeper for keeper trade recommendations comprises the following steps: evaluate all potential keepers on other teams for trade to the team manager's team by moving one keeper at a time from the opposing team's roster to the team manager's roster and rerunning the method for calculating keeper value, evaluate all potential keepers on the team manager's roster for trade to the other team by moving them one at a time from the team manager's roster to the opposing team roster and rerunning the method for calculating keeper value, if a player from another roster ends up becoming a recommended keeper on the team manager's team and then keeping the player on the team manager's roster, exchange these two players, with both teams increasing their probability of winning the championship, with a mutually beneficial keeper trade having been identified and the keeper for keeper trade being recommended. The method for generating keeper for draft pick trade recommendations comprises the following steps, evaluate all potential keepers on other teams for trade to the team manager's team by moving keepers one at a time from the opposing team's roster to the team manager's roster and rerunning the method for calculating keeper value, evaluate an exchange of draft picks where the opposing team(s) give the pick necessary to keep the potential keeper and the team manager's team gives the pick closest to have the value greater than the pick required for keeping it and rerunning the method for calculating keeper value, if a player from another roster ends up becoming a recommended keeper on the team manager's team, then keeping the player on the team manager's roster, exchanging these two players, with both teams increasing their probability of winning the championship and a mutually beneficial keeper trade has been identified and the keeper for draft pick trade is recommended, rerun moving each draft pick-up and down until no better trade is found, repeat all steps except reverse the team giving the keeper and the team giving the higher draft pick so the team manager is surrendering potential keepers to opposing teams and the opposing teams surrenders the higher draft pick. As potential keeper trades are recommended they are displayed on the Keeper Trades page 570, including the keeper or draft pick to surrender 571, the improvement to the team manager's team 573, the team to trade with 575, the keeper or draft pick being received 577 and the improvement to the opposing team 579.

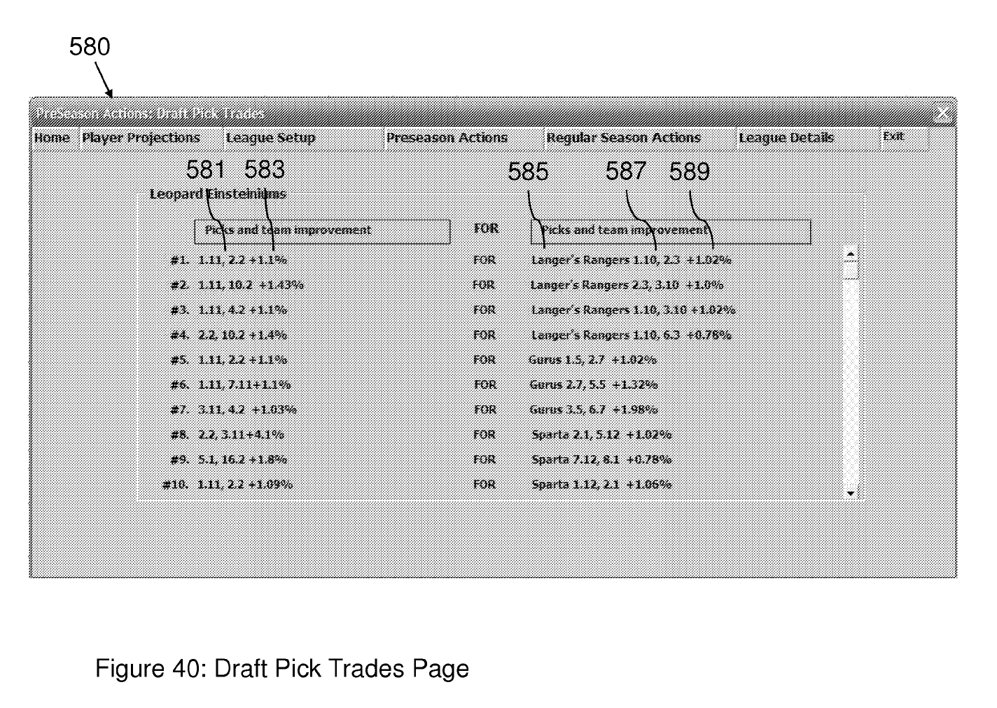

A Draft Pick Trades page 580 shown in FIG. 40 enables the team manager to generate and view recommended draft pick trade proposals. There are generally two types of draft pick trades, trading up and trading down. Trading up is when a team receives a higher draft pick (earlier) than the highest pick that it surrenders. Trading down is the opposite. Usually a team manager is trying to do one or the other. Although only the overall impact to the probability of winning the championship is important, the subjective motivation of other team managers often creates opportunities for finding beneficial draft picks trades. The goal of the method for generating draft pick trade recommendations is to present at least one trade up and one trade down to each of the other teams above a certain threshold for improving the team manager's probability to win the championship. The team manager first selects a goal for improving the probability of winning the championship for each trade proposal. By default, this value is set to one percent (1%). The higher the value, the more beneficial the proposed trades are for the team manager's team, but the less likely the opposing team manager is to accept the trade. All trade proposals have a balanced number of picks being acquired versus being surrendered. The initial value of a trade is the normalized value of all acquired picks minus the normalized value of all surrendered picks. To generate trade recommendations, the trade generator tries different combinations of picks and recommends trades that meet the following criteria: the trade has equal or greater value to the team manager's team than the selected trade value threshold, the trade has the greatest or near greatest value to the opposing team, even if the value is negative. The generator generates valid trade combinations by starting with each of the highest picks of the two teams. Then whichever team the exchange of the top two picks favors more relative to the trade threshold, that team's next pick and whatever pick on the opposing team that causes the balance to most closely match the threshold are then selected next. Then again, whichever team the exchange of those four picks favor the most relative to the trade threshold, that team's next highest pick under the lowest pick of the previous pair is matched with the opposing team's pick again to make the trade match as closely as possible to the selected threshold. This process is repeated until there are no more picks to choose from. The steps are repeated, except that the top remaining pick is eliminated from the list of available picks to choose from. So if draft picks are still in their natural order at this point, the generated combinations alternate between trading up and trading down. Finally, all trade values are validated by rerunning the mock draft generator. If a trade does not meet the threshold of trade value after validation, the generator moves a pick-up or down based on the normalized draft value table that most closely matches what is required to get as close to the threshold as possible. This is repeated until no combination can be found that comes closer to the trade threshold. Then trades are sorted from high to low for the value they have for the opposing team. Then the best up trade and best down trade between the team manager's team and each opposing team is recommended to the team manager as trades to propose to the other teams. The Draft Pick Trades page displays each recommended draft pick trade including draft picks to surrender 581, value of the trade to the team manager 583, the team to trade with 585, the draft picks to be received 587 and the value to the opposing team 589.

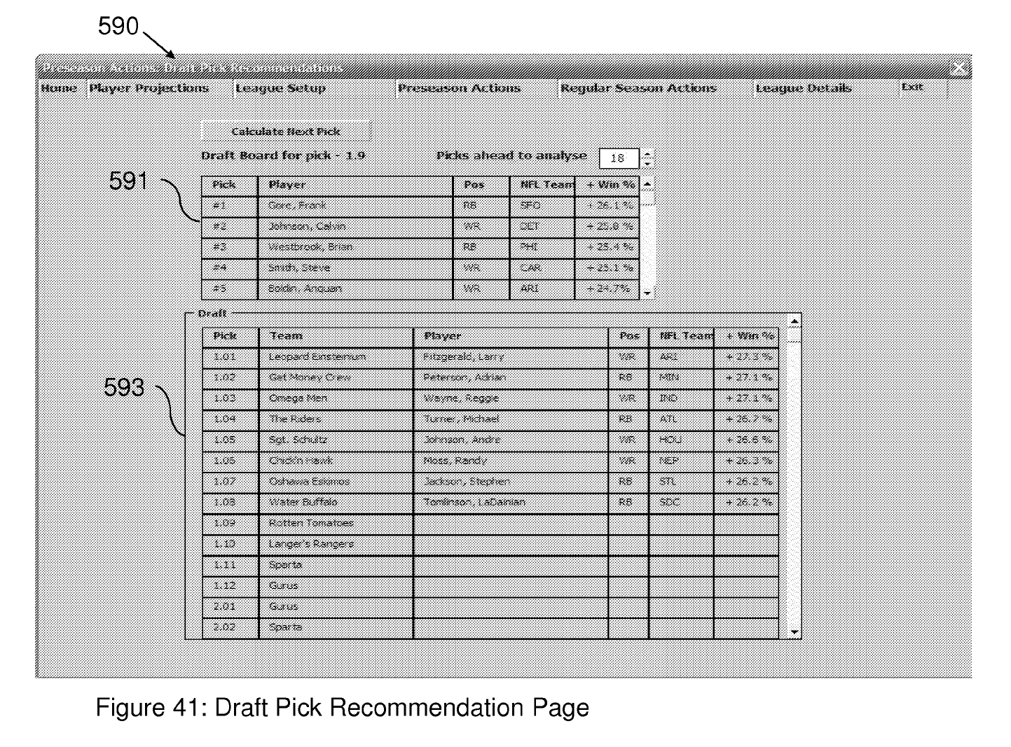

A Draft Pick Recommendations page 590 shown in FIG. 41 provides an interactive means for the team manager to generate and view recommended draft pick selections. The method for generating draft recommendations is comprised of the following steps: the top player of each position based on total season fantasy points is evaluated one at a time as a draft pick by inserting the player on the roster of the team on the clock and running the season calculator, for whichever position yielded the highest value the next best player of that position is evaluated as a draft pick, if the value of that player yields a higher value than any of the other positions, then the next player of that position is evaluated the next best player for whichever of the other positions that yielded the highest value is evaluated, these steps repeat until two times the number of players are evaluated as there are positions in the league. If the best selection is greater than the next best selection by more than the normalized draft pick value of the draft pick one round away, that player is recommended. If the difference between the best selection and any other selection is less than the normalized draft pick value one round away, the top pick for the next team on the clock is selected using the same method. If the top pick for the next team still does not make the difference between the top two picks for the user's team to be greater than the normalized pick value one round from the next team's pick, the method looks ahead to the next team and so on until the best pick for the team manager's team is better than any other pick by more than the normalized draft pick value one round away from the last team for which look-ahead draft picks are being made. The Draft Pick Recommendations page 590 provides an up-to-date view of draft pick recommendations as they are being generated, including top picks 591 and the current standing of the draft 593. The team manager can make a draft pick by confirming one of the recommended picks or by entering an alternate selection.

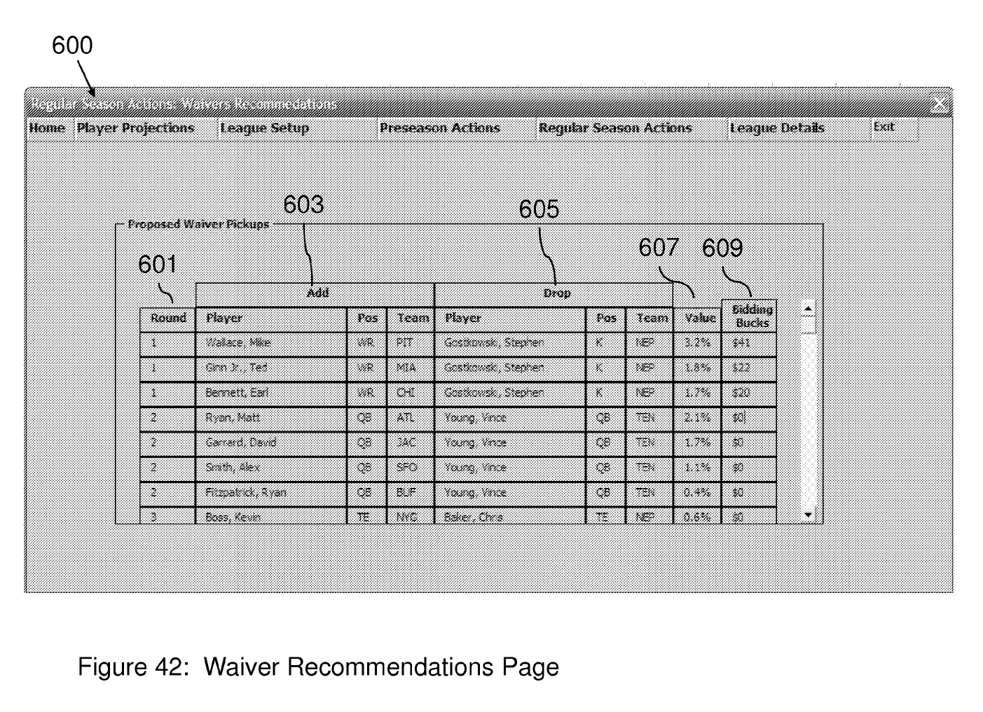

A Waiver Pick Recommendations page 600 shown in FIG. 42 enables the team manager to view recommended waiver transactions. The method for generating waiver transaction recommendations is comprised of the following steps: generate and sort possible waiver transactions, determine the value of possible waiver transactions, sort waiver transactions with positive value into prioritized recommendations for each round of waiver transactions and generating bidding buck recommendations (if any). The transaction generator 79 generates a list of all possible waiver transactions. Then the list is sorted from highest to lowest of the difference of the projected fantasy points for the remainder of the fantasy football season for the player to add minus the player to drop. This generally causes the more likely beneficial waiver transactions to be listed first. Starting at the top of the list are the possible waiver transactions that are processed by the season calculator 400. If a transaction has negative value, then all unprocessed transactions in the list that either have a higher valued player to drop and the same player to pick-up, or the same player to drop and a lower player to pick-up are pruned from the list. Next waiver transactions with positive value are sorted into meaningful waiver rounds. Starting with the most valuable waiver transaction, all other waiver transactions that drop the same player and pick-up a player of the same position of the best transaction are sorted from most valuable to least valuable and are recommended for the first round of waivers. Players that might possibly be added from the first round are removed from the remaining transactions list and the process is repeated for the next round. The same process repeats for additional rounds of waivers until there are either no additional players to drop or no additional players to add. If there are additional players to add, then whatever transaction has the greatest value that drops the same player used for the previous first round recommendations is added to the list of first round waiver recommendations and any other transactions dropping a player of the same position for picking-up the same player off of waivers. The first round waiver recommendations are sorted again from most valuable to least valuable. Then using the same process, additional waiver transactions are added to the second round and so on until no transactions remain or until there are as many recommended transactions for a round as there are teams. The following formula for recommending the maximum bidding bucks to spend in a week considers these factors:

SWB

SW+2S−2W

where S is the number of weeks in the fantasy league season, W is the week of the season and B is the available number of bidding bucks. Furthermore, no more bidding bucks are recommended to be used in a particular week than would allow for one bidding buck to be spent every week for the rest of the season. Bidding bucks are recommended only for the first round of waivers for transactions that have more value than the best transaction recommended in the second round. Also recommendations for each of these transactions are proportional to their relative value between the best waiver transaction of round 1 and the best waiver transaction of round 2. For example, if the maximum bidding bucks for week 1 is 33, then 33 bidding bucks would be recommended for the first recommendation for the first round. Let's say that a given transaction provides an estimated five percent (5%) improvement to the user's team and the second best recommended transaction provides a four percent (4%) benefit, the third a three percent (3%) benefit and the fourth, a two percent (2%) benefit and the top transaction for round 2 provides a two percent (2%) benefit as well. Then it would be recommended to use 33 bidding bucks for the round 1 first transaction, 22 ((4−2)/(5−2) or 66% of the max bidding bucks) for the round 1 second transaction, 11 ((3−1)/(5−2) or 33% of the max bidding bucks) for the round 1 third transaction and no bidding bucks for all remaining recommended waiver transactions. The Waiver Recommendations page 600 displays information for each recommended waiver transaction including waiver round 601, player to add 603, player to drop 605, the value of the transaction 607 and the bidding bucks to offer 609.

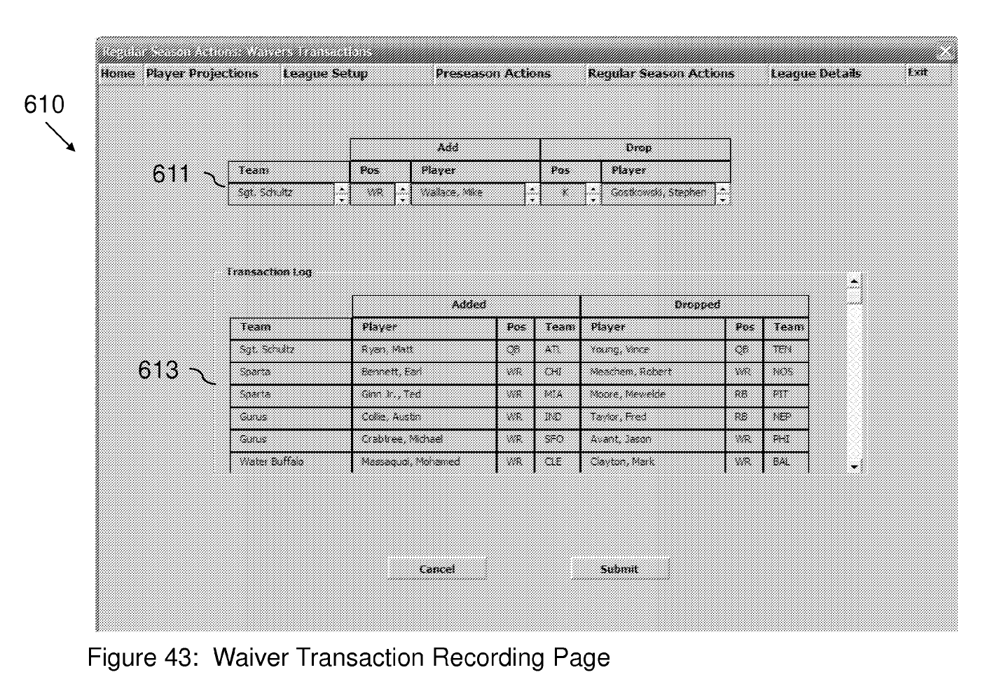

A Waiver Transaction Recording page 610 shown in FIG. 43 enables the team manager to record waiver transactions through a dialogue area 611 and view a waiver transaction log 613. Recording waiver transactions is important for keeping the league rosters up to date.

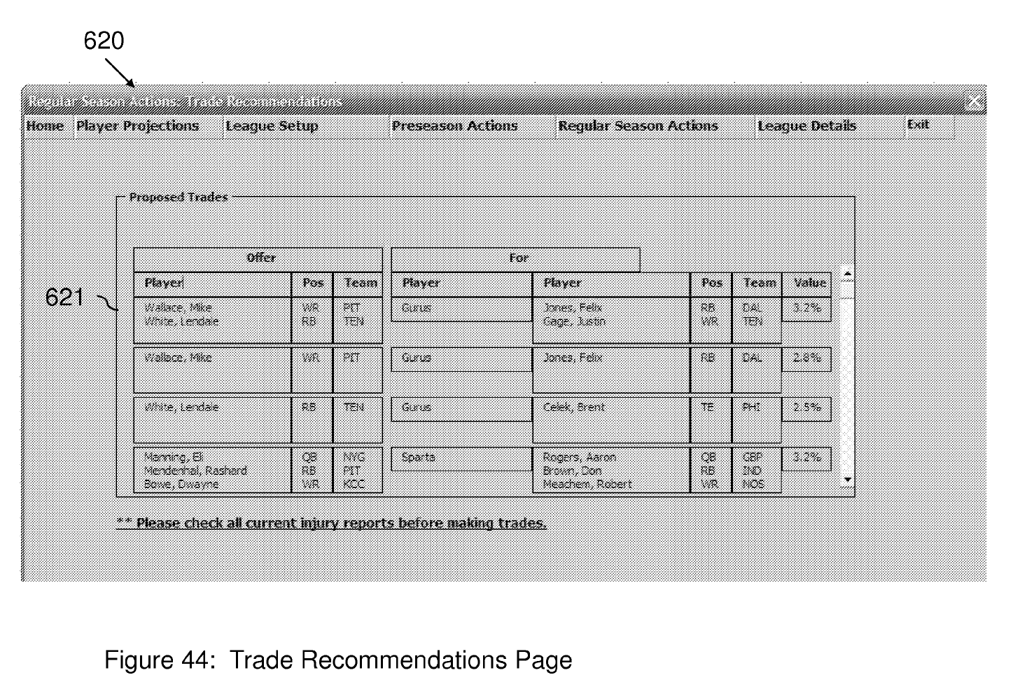

A Trade Recommendations page 620 shown in FIG. 44 enables the team manager to view recommended trades. The method for generating trade recommendations is comprised of the following steps: find the relative fantasy point strength for all players, process pseudo-waivers for each opposing team, generate combinations of possible trades, and evaluate possible trades with the season calculator 400 and sort and present trade proposal recommendations to the team manager. Relative fantasy point strength is the difference between a player's remaining projected fantasy points for the season and that of the average starter for the same position. For example, in a twelve-team league where each team starts one quarterback, the top twelve quarterbacks fantasy point projections for the remainder of the season are averaged together to find the average projected fantasy points for a starting quarterback. The reason for processing pseudo waivers is to account for the value of players that are available from waivers so that the recommended trade proposals are more balanced. Without processing pseudo waivers, a top place kicker PK will be valued the same as a top running back RB. Those knowledgeable in fantasy football know that a top RB is generally much more valuable than a top PK. The method for processing pseudo waivers is exactly the same as generating waiver recommendations for the team manager's team, except that it is applied one at a time to each opposing team and the final waiver transaction recommendations are actually processed to create a pseudo-roster of the opposing team. Players that are added by the waiver transactions are flagged as being unavailable for trade proposals and are not included among the possible trade combinations. Pseudo-waivers are processed for one team and then possible trades are generated and evaluated between the team manager's team and the one opposing team. Then the opposing team's original roster is restored and pseudo-waivers are processed for the next opposing team and so forth, until all possible trades with all opposing teams have been evaluated. The method for generating trade recommendations generates all possible 1-for-1, 2-for-2 and 3-for-3 trades between the user's team roster and the opposing team's pseudo roster, excluding players that were added from pseudo-waivers. In a league that keeps 18-player rosters, it could generate approximately 2.4 million possible trades between the two teams. As trade combinations are generated, they are sorted based on the magnitude of the sum of the relative fantasy points of players being acquired by the team manager's team minus the sum or the relative fantasy points of the players being surrendered to the opposing team. The smaller the magnitude, the more likely the trade is to be balanced, so the list is sorted from small to large for evaluation of each trade. As the season calculator evaluates possible trades, the list is pruned based on recognizing similar trade proposals have lesser value than a trade proposal that is rejected. The tasks of generating the trade proposal list and pruning the list through season calculator evaluations can be combined to reduce the memory and computer requirements before the trade recommendations method. The Trade Recommendations page 620 shows the recommended trade proposals 621, sorted by the opposing team before and after value. Even if the benefit to the opposing team is negative, at least one trade recommendation is generated for each opposing team.

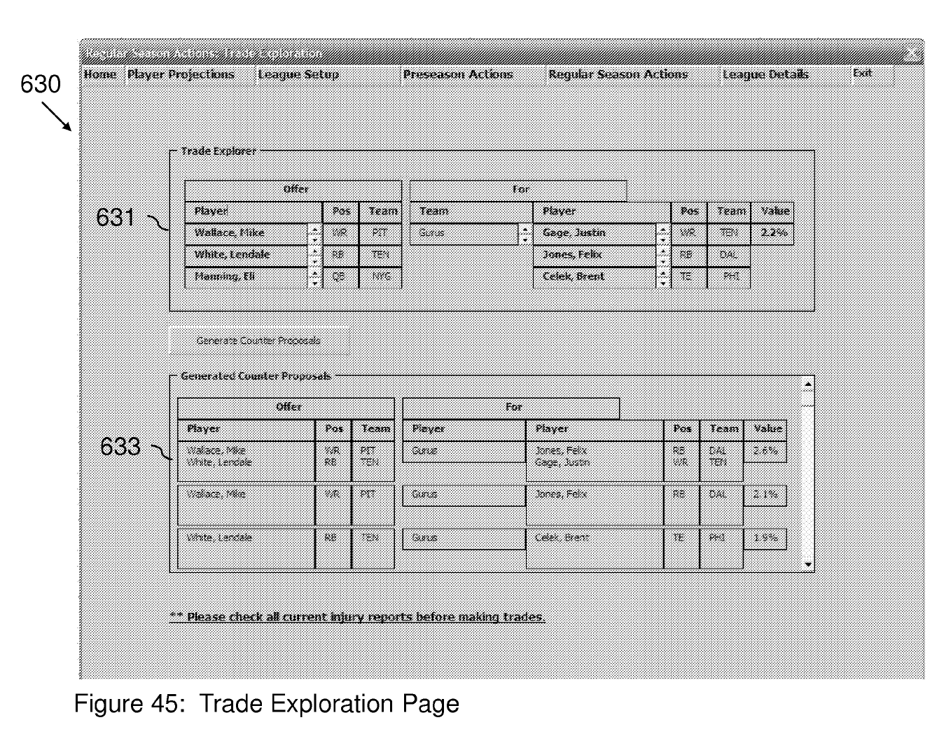

A Trade Exploration page 630 shown in FIG. 45 enables the team manager to evaluate trades of his choice or proposed by other teams. Trade evaluations use the same method used for generating trade recommendations, including processing pseudo waivers. If a trade has negative value to the team manager's team, the team manager can initiate a generation of counterproposals. The counterproposals generator also uses the same method, except that only trades that involve at least one of the players involved in the original trade proposal are used. The Trade Exploration page 630 has a dialogue box for entering trade proposals to evaluate 631 and shows the result of generated recommended counterproposals 633.

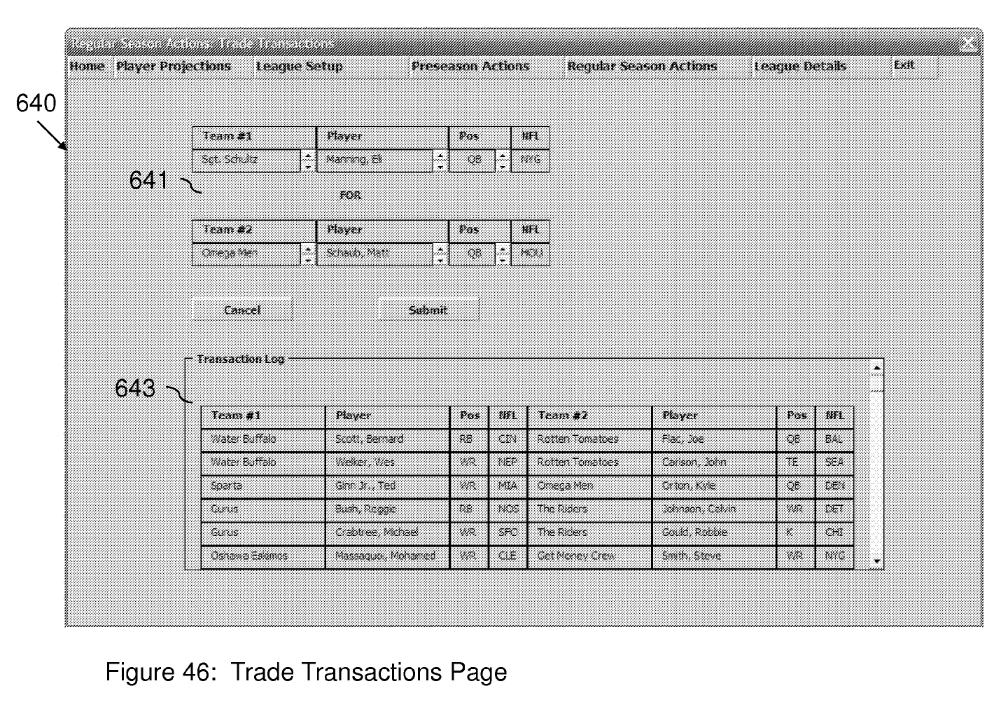

A Trade Transaction Recording page 640 shown in FIG. 46 enables the team manager to record trade transactions through a dialogue area 641 and view a trade transactions log 643. Recording trade transactions is important for keeping the league rosters up to date.

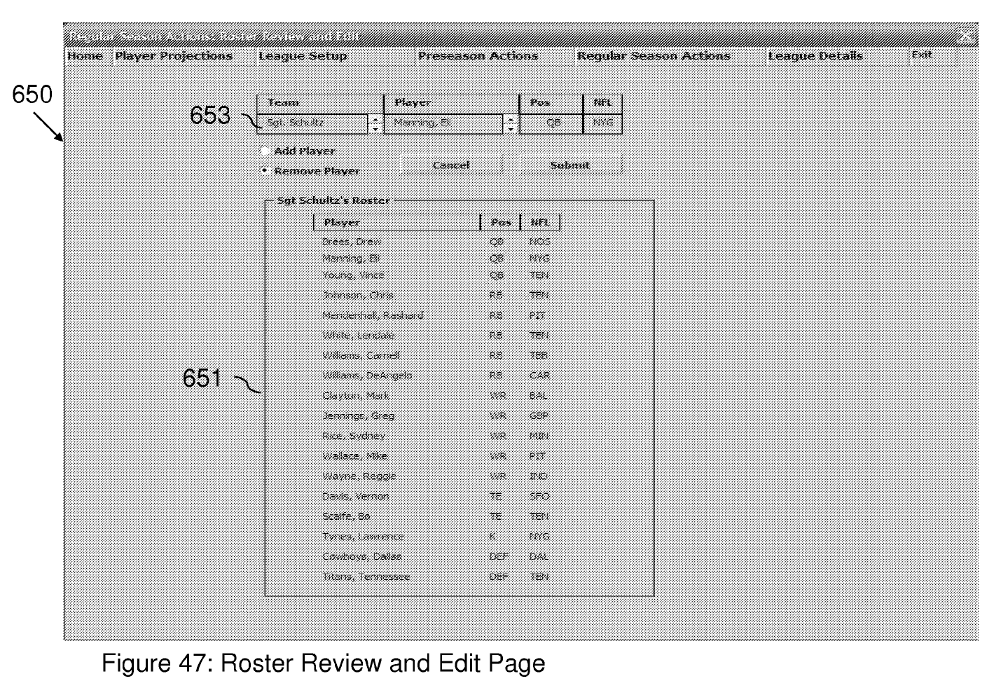

A Roster Review and Edit page 650 shown in FIG. 47 enables the team manager to view team rosters 651 and edit the rosters in a dialogue area 653. If for any reason team rosters become out of sync with the actual fantasy league's rosters, the team manager can use this method to directly edit the team rosters instead of being required to enter transactions.

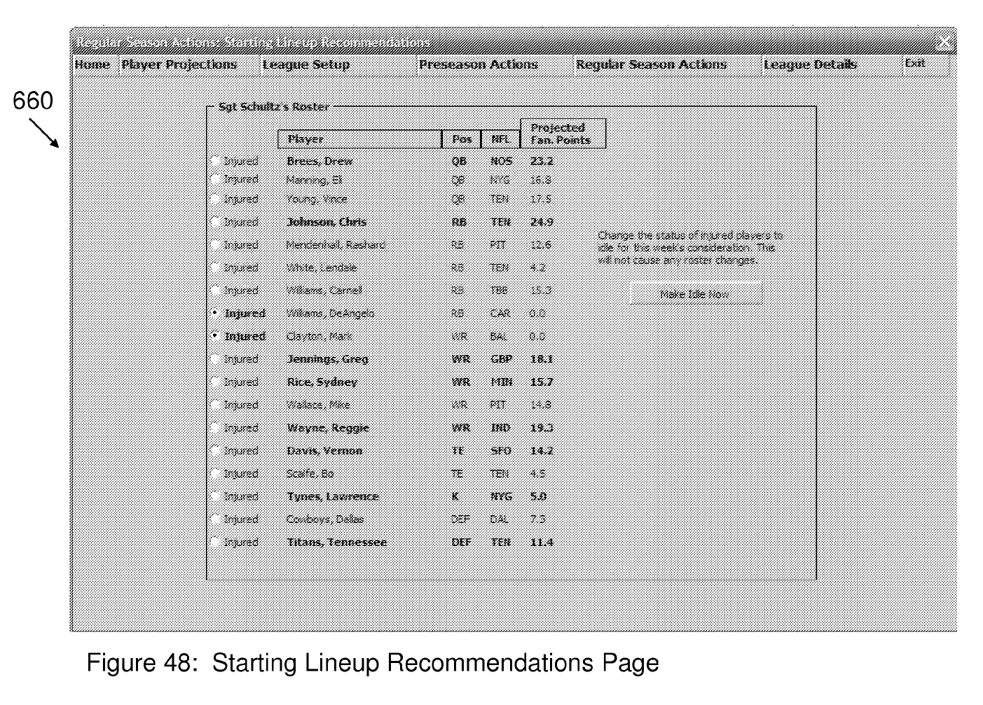

A Starting Line-up Recommendations page 660 shown in FIG. 48 shows the recommended starting line-up for a given week, including back-ups if a starter becomes injured before a game. Starting line-up recommendations are created as the first step 411 of the season calculator 400.

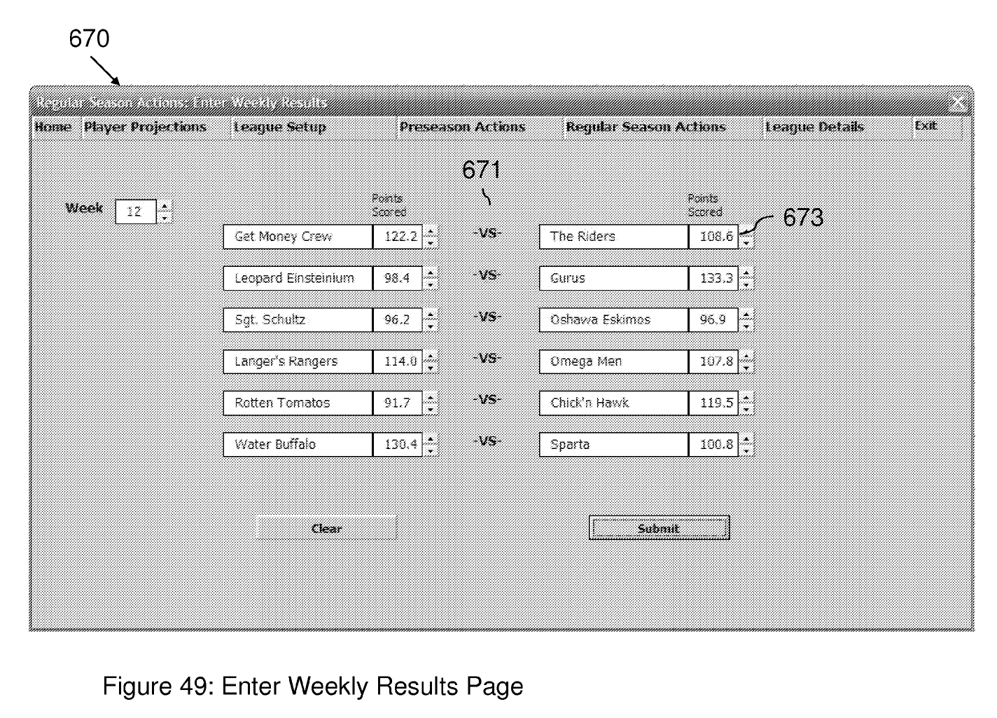

An Enter Weekly Results page 670 shown in FIG. 49 enables the team manager to enter weekly results so the season calculator 400 can factor the outcome of games into projections moving forward. For each week, the match-ups are displayed 671 and a box 673 is provided for the team manager to enter the fantasy points achieved by each team.

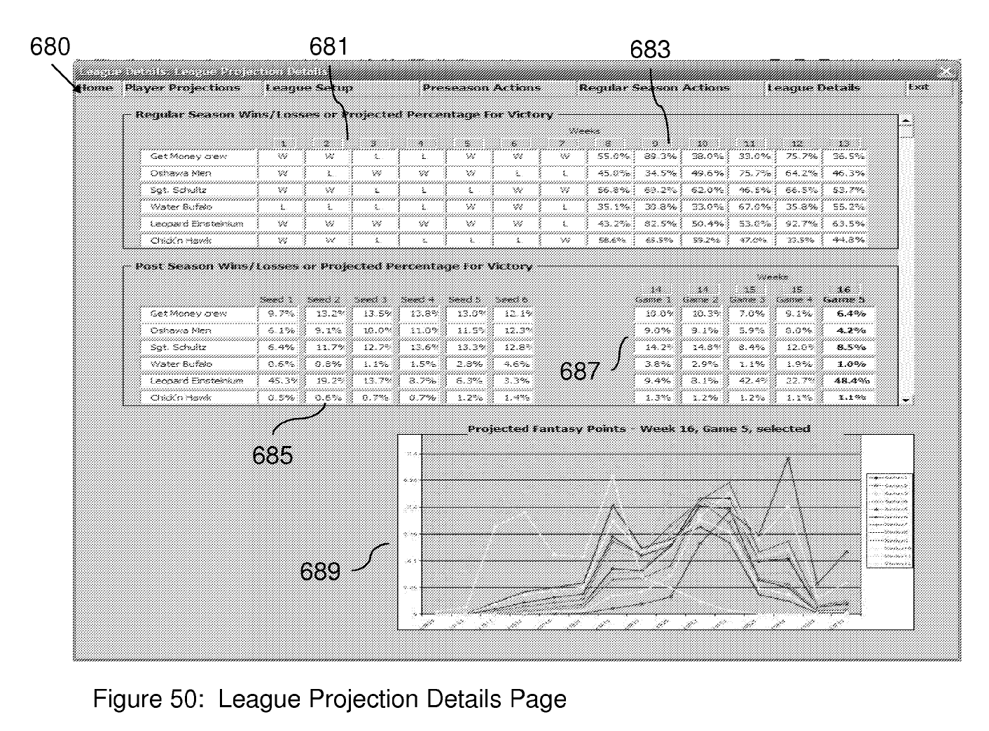

A League Projections Details page 680 shown in FIG. 50 enables the team manager to view overall league information, such as win/loss results 681, match-up projections 683, playoff seed projections 685, playoff projections 687 and weekly team fantasy point projections 689.

A key aspect of the System and Method for Managing a Fantasy Sports Team is that it offers an automated approach to deciding keepers, waivers, trades and starting line-ups. Instead of requiring the manager to explicitly try all trades, keepers, and starting line-ups, the management software 21 considers all reasonable possibilities automatically and just informs the manager of the best keepers, waiver transactions, trades that should be proposed to other teams and line-up decisions. With respect to trade recommendations and evaluations, the management software 21 provides several unique capabilities:
Using pseudo players to fill in roster spots for evaluating draft picks.
Performing pseudo waiver substitution to balance rosters prior to performing trade analysis. Without this capability, trade analysis will only consider players on rosters and not consider their value relative to players readily available from waivers. For example, in fantasy football, a top running back is typically more valuable than a top kicker. Without performing pseudo players, they might be valued by the season calculator almost as equal and therefore unreasonable trade proposals would be recommended. By processing pseudo waivers, trade recommendations are more reasonable and have a more likely chance of acceptance by the other team manager.
Generating trade counterproposals. Opposing team managers often make trade proposals that benefit their team but are detrimental to the team for which the management software 21 is providing guidance. The management software 21 attempts to keep an open door to trade by proposing counter offers based on each player the opposing manager presented in his trade offer. For example, if the opposing team manager proposes to trade player A and B from his team for player C and D for the team for which the management software 21 is providing guidance and the management software 21 determines it is not a beneficial trade, the management software 21 may generate the four most reasonable and beneficial trades, one for each of players A, B, C, and D.

The management software 21 considers the probability distribution of projections and makes recommendations to fantasy team owners based on mathematically-correct functions.

The disclosed system and method uses player fantasy point probability distributions rather than player statistics or fantasy point projections and provides recommendations for all team management transactions, such as waiver and trade recommendations and all guidance is based on a season calculator 400 that uses the player fantasy point probability distributions to measure all transactions directly as a percent improvement a team has to win a league championship. Although some modifications to the above descriptions may vary for different fantasy sports, basic aspects of the disclosure are the same for all fantasy sports:
Player projections are converted to probability distributions based on:
   league scoring rules
   statistical deviation of how much projections change over time
   statistical deviation of how well projections match actual results
   statistical probability that a zero fantasy point event will occur, such as a season ending injury.
The invention provides the user with recommendations for all transactions to manage the team based upon the transaction generator 79 that runs an intelligent set of possible transactions through the season calculator 400, to provide transactions that are beneficial for the team.
The season calculator 400 uses probability distributions to perform a league specific simulation of the season.
Draft transactions are measured using psuedo players to fill in yet unfilled roster spots.
A mock draft runs to measure the value of each draft pick towards winning the championship and then to value keepers and to make draft pick trade recommendations.
Regular season trade recommendations process psuedo waivers to account for the value of players readily available from waivers.

The management software 21 may be applied to all fantasy sports that make team management decisions based on anticipated results of players or teams. Applicable fantasy sports include, but are not limited to, American football, European football (soccer), rugby, cricket, basketball, and baseball. Elements of the management software 21 can be used in their entirety or in part. For example, an application could be specified to provide recommendations for all team transactions that did not use probability distributions, but simply fantasy point projections.

The management software 21 provides all of the described recommendations to manage a sports fantasy team, although the season calculator 400 could be scaled down and made simpler. Alternatively, an application could be specified to use fantasy point probability distributions and a complete season calculator 400, based on the fantasy point probability distributions, but provide only partial guidance because no transaction generator 79 may be specified. The following list includes different embodiments of the disclosed method and system:

A season calculator.

A season calculator based on player probability distributions.

A draft calculator tied to a season calculator.

A draft calculator based on player probability distributions tied to a season calculator.

A draft calculator that generates averaged (pseudo) player probability distributions for undrafted picks tied to a season calculator.

An analysis of all team manager decisions (such as keepers, trades, waivers, starting line-ups) tied to a season calculator.

An analysis of all team manager decisions tied to a season calculator based on player probability distributions.

An automatic generation of recommended team manager decisions (rather than manager being required to query) tied to a season calculator.

An automatic generation of recommended team manager decisions tied to a season calculator based on player probability distributions.

The present invention can also be used to find fantasy sports teams with a high probability of winning. The present invention can be used in other ways other then to manage a fantasy sports team. For example, the invention can also be used to snoop fantasy leagues so insurance companies can prospect and identify team managers to offer Fantasy Sports Insurance to. The invention would be the same, but the purpose would be different, except that no user interface would be needed to do this.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1-32. (canceled)

33. An automated method for managing a sports team, comprising:
setting up league specific scoring rules for a sport team;
creating a match-up schedule for a sport team; and
converting commercially available sport projections into sport team recommendations using a season calculator to provide guidance to a sport team manager thereby increasing a sport team's probability of winning a league championship.

34. The automated method for managing a sports team of claim 33, wherein the season calculator uses probability distributions to convert commercially available sport projections into sport team recommendations.

35. The automated method for managing a sports team of claim 34, wherein the projections' variance and the projections' accuracy are used to build the probability distributions.

36. The automated method for managing a sports team of claim 33, wherein the projections are player projections.

37. The automated method for managing a sports team of claim 33, wherein the projections are weekly projections.

38. The automated method for managing a sports team of claim 33, wherein the projections are projected season statistics.

39. The automated method for managing a sports team of claim 33, wherein the projections are capable of being manually modified and recalculated.

40. The automated method for managing a sports team of claim 33, further comprising the step of providing a transaction generator.

41. The automated method for managing a sports team of claim 40, wherein the transaction generator selects tasks comprising pre-season (pre-draft) and regular season (post-draft) tasks.

42. The automated method for managing a sports team of claim 33, further comprising the step of generating pseudo-players, wherein the pseudo-players are used in simulated (mock) draft, auction-style, and draft pick analyses and recommendations.

43. The automated method for managing a sports team of claim 33, further comprising the step of generating pseudo-waivers, wherein the pseudo-waivers are used in trade analyses, recommendations and counter-proposals.

44. The automated method for managing a sports team of claim 33, wherein the recommendations comprise draft, keeper, trade, starting line-up, and waiver recommendations.

45. The automated method for managing a sports team of claim 33, wherein the league is an off-season league.

46. The automated method for managing a sports team of claim 45, wherein the off-season league is a keeper league.

47. An automated system for managing a sports team, comprising:
providing a computer configured to set up league specific scoring rules for a sport team; create a match-up schedule for a sport team; and convert commercially available sport projections into sport team recommendations using a season calculator to provide guidance to a sport team manager thereby increasing a sport team's probability of winning a league championship.

48. The automated system for managing a sports team of claim 47, wherein the season calculator is configured to use probability distributions to convert commercially available sport projections into sport team recommendations.

49. The automated system for managing a sports team of claim 48, wherein the projections' variance and the projections' accuracy are used to build the probability distributions.

50. The automated system for managing a sports team of claim 47, wherein the projections are player projections.

51. The automated system for managing a sports team of claim 47, wherein the projections are weekly projections.

52. The automated system for managing a sports team of claim 47, wherein the projections are projected season statistics.

53. The automated system for managing a sports team of claim 47, wherein the projections are capable of being manually modified and recalculated.

54. The automated system for managing a sports team of claim 47, further comprising the step of providing a transaction generator.

55. The automated system for managing a sports team of claim 54, wherein the transaction generator is configured to select tasks comprising pre-season (pre-draft) and regular season (post-draft) tasks.

56. The automated system for managing a sports team of claim 47, further comprising the step of generating pseudo-players, wherein the pseudo-players are used in simulated (mock) draft, auction-style, and draft pick analyses and recommendations.

57. The automated system for managing a sports team of claim 47, further comprising the step of generating pseudo-waivers, wherein the pseudo-waivers are used in trade analyses, recommendations and counter-proposals.

58. The automated system for managing a sports team of claim 47, wherein the recommendations comprise draft, keeper, trade, starting line-up, and waiver recommendations.

59. The automated system for managing a sports team of claim 47, wherein the league is an off-season league.

60. The automated system for managing a sports team of claim 59, wherein the off-season league is a keeper league.
